(19) United States
(12) Patent Application Publication
(10) Pub. No.: US 2023/0397238 A1
(43) Pub. Date: Dec. 7, 2023

(54) SYSTEM AND METHOD FOR WIRELESS COMMUNICATION AND STORAGE MEDIUM

(71) Applicant: Sony Group Corporation, Tokyo (JP)

(72) Inventors: Youping ZHAO, Beijing (CN); Mengting LIN, Beijing (CN); Zhong TIAN, Beijing (CN); Chen SUN, Beijing (CN)

(73) Assignee: Sony Group Corporation, Tokyo (JP)

(21) Appl. No.: 18/033,566

(22) PCT Filed: Nov. 12, 2021
(86) PCT No.: PCT/CN2021/130198

§ 371 Date: Apr. 25, 2023

(30) Foreign Application Priority Data
Nov. 13, 2020 (CN) 202011271371.5

(51) Int. Cl. H04W 72/541; H04W 72/563; H04W 72/0453

(52) U.S. Cl. CPC H04W 72/541; H04W 72/563; H04W 72/0453

(57) ABSTRACT

Provided are a system and a method for wireless communication, and a storage medium. A system for wireless communication comprising: one or more intra-slice managers, at least one of the one or more intra-slice managers is configured for collecting scenario information of a corresponding RAN slice of a plurality of RAN slices in a wireless network, wherein the scenario information is used for determining at least the following: an interference relation between RAN slices, a RAN slice priority and a RAN slice spectrum resource requirement; a first management means, configured for determining an orchestration or re-orchestration scheme of spectrum resources among the RAN slices at least based on the scenario information, wherein the orchestration or re-orchestration scheme of spectrum resources among the plurality of RAN slices includes a first characteristic and quantity of spectrum resources to be allocated to at least one of the plurality of RAN slices.

This application claims the priority to the Chinese patent application No. 202011271371.5 filed on Nov. 13, 2020 and entitled “SYSTEM AND METHOD FOR WIRELESS COMMUNICATION AND STORAGE MEDIUM”, the disclosure of which is incorporated herein by reference in its entirety.

### TECHNICAL FIELD

This disclosure relates generally to a wireless communication system, and specifically to technologies related to network slicing in the wireless communication system.

### BACKGROUND

In a wireless communication system, as scenarios to which wireless communication is to be applied have been increasingly complicated, in order to enable an operator to provide customized logical networks for users to satisfy diverse service requirements, it is considered to divide a network into a plurality of virtual network slices according to different service characteristics and requirements corresponding to different application scenarios. Such technology of dividing a network into a plurality of virtual network slices is referred to as Network Slicing, for example, in 5G/B5G. The network slicing can generally include core network slicing, radio access network (RAN) slicing, and transport network slicing.

The network slicing enables to slice one physical network into a plurality of virtual end-to-end networks, and devices, access, transport, and core network included in respective virtual networks are logically independent between the networks, so that failure of any of the virtual networks will not affect other virtual networks. Each virtual network has different function characteristics for different requirements and services.

There is a need fora technology that enables efficient network slicing.

### SUMMARY

The present disclosure provides a solution related to network slicing, and specifically, provides a system and method for a wireless communication system, and a computer-readable medium.

One aspect of the present disclosure relates to a system for wireless communication, comprising: one or more intra-slice managers, at least one of the one or more intra-slice managers is configured for collecting scenario information of a corresponding Radio Access Network (RAN) slice of a plurality of RAN slices in a wireless network, wherein, the scenario information is used for determining at least the following information: an interference relation between RAN slices, a RAN slice priority and a RAN slice spectrum resource requirement; and a first management means, configured for determining an orchestration or re-orchestration scheme of spectrum resources among the plurality of RAN slices at least based on the scenario information, wherein the orchestration or re-orchestration scheme of spectrum resources among the plurality of RAN slices includes a first characteristic and quantity of spectrum resources to be allocated to at least one RAN slice of the plurality of RAN slices.

Another aspect of the present disclosure relates to a method for a system for wireless communication, the system comprising one or more intra-slice managers and a first management means, the method comprising collecting, by at least one intra-slice manager among the one or more intra-slice managers, scenario information of a corresponding Radio Access Network RAN slice of a plurality of RAN slices in a wireless network, wherein the scenario information is used for determining at least the following information: an interference relation between RAN slices, a RAN slice priority and a RAN slice spectrum resource requirement; determining, by the first management means, an orchestration or re-orchestration scheme of spectrum resources among the plurality of RAN slices at least based on the interference relation between RAN slices, a RAN slice priority and a RAN slice spectrum resource requirement, wherein the orchestration or re-orchestration scheme of spectrum resources among the plurality of RAN slices includes a first characteristic and quantity of spectrum resources to be allocated to at least one RAN slice of the plurality of RAN slice.

Another aspect of the present disclosure relates to a non-transitory computer-readable storage medium having thereon stored executable instructions which, when executed, implement the method of the above aspect.

### BRIEF DESCRIPTION OF THE DRAWINGS

When the following specific description of embodiments is considered in conjunction with the drawings, a better understanding of the present disclosure can be obtained. Same or similar reference numbers are used in the drawings to represent same or similar components. The accompanying drawings together with the following specific description, which are included in and form a part of the specification, serve to exemplify the embodiments of the present disclosure and explain the principles and advantages of the present disclosure, wherein:

FIG. 1 schematically illustrates a scenario of a wireless communication system to which a solution of the present disclosure can be applied;

FIG. 2 schematically illustrates a schematic diagram of a configuration of a system for wireless communication according to an embodiment of the present disclosure;

FIG. 3 schematically illustrates a first conceptual operation flow of a method for a system for wireless communication according to an embodiment of the present disclosure;

FIG. 4 schematically illustrates a flow diagram of an exemplary algorithm for determining an orchestration or re-orchestration scheme of spectrum resources among the plurality of RAN slices;

FIG. 5 schematically illustrates a second conceptual operation flow of a method for a system for wireless communication according to an embodiment of the present disclosure;

FIG. 6 schematically illustrates first exemplary information interaction according to an embodiment of the present disclosure;

FIG. 7 schematically illustrates second exemplary information interaction according to an embodiment of the present disclosure;

FIG. 8 schematically illustrates third exemplary information interaction according to an embodiment of the present disclosure;

FIG. 9 schematically illustrates a diagram of a base station position scenario for simulation of a solution of the present disclosure;

FIG. 10 schematically illustrates a comparison diagram of average spectrum satisfaction of RAN slices in the case of applying the method according to the present disclosure and the case of not applying the method according to the present disclosure;

FIG. 11 schematically illustrates a comparison diagram of average spectrum satisfaction of base stations in the case of applying the method according to the present disclosure and the case of not applying the method according to the present disclosure; and

FIG. 12 is a block diagram of an exemplary structure of an computer/computer system employable in an embodiment of the present disclosure.

While the embodiments described in this disclosure may easily have various modifications and alternative forms, specific embodiments thereof are shown as examples in the drawings and described in detail herein. It should be understood, however, that the drawings and the detailed description thereto are not intended to limit the embodiments to the specific form disclosed, but to cover all modifications, equivalents and alternatives falling within the spirit and scope of the claims.

### DETAILED DESCRIPTION

Representative applications of various aspects such as the device and method according to the present disclosure are described below. These examples are described merely to add context and help understanding the described embodiments. Therefore, it is apparent to those skilled in the art that the embodiments described below can be practiced without some or all of the specific details. In other cases, well-known processing steps are not described in detail to avoid unnecessarily obscuring the described embodiments. Other applications are also possible, and solutions of the present disclosure are not limited to these examples.

Typically, the system for wireless communication according to the present disclosure at least comprises device(s) (such as various virtualized or non-virtualized network element devices responsible for corresponding functions) of a core network side.

In the present disclosure, a “core network device” is, for example, a general name for a plurality of network element devices, and a single network element device can implement a single function, a single network element device can implement a plurality of functions, or a plurality of network element devices can implement a single function. As an example, Network Function Virtualization (NFV) or Software Defined Network (SDN) can be applied to the core network, and in this case, the network element device in the core network can be a software module implementing a corresponding function.

Furthermore, the system for wireless communication according to the present disclosure can further comprise device(s) (such as base station(s) and terminal device(s)) of an access network. In this disclosure, a “base station” at least comprises a wireless communication station that is part of a wireless communication system or radio system to facilitate communication. As an example, the base station can be, for example, an eNB of the 4G communication standard, a gNB of the 5G communication standard, a remote radio head, a wireless access point, a drone control tower, or a communication device performing similar functions. In this disclosure, a “terminal device” or “User Equipment (UE)” at least comprises a terminal device that is part of a wireless communication system or radio system to facilitate communication. As an example, the terminal device can be a terminal device such as a mobile phone, a laptop, a tablet, a vehicle-mounted communication device, or an element thereof.

As described in the “BACKGROUND”, in the wireless communication system, it is considered to divide a network into a plurality of virtual network slices according to different service characteristics and requirements corresponding to different application scenarios, and network slicing can generally include core network slicing, RAN slicing, and transport network slicing. In this disclosure, content related to the RAN slicing is mainly discussed. Hereinafter, the term “slicing” or “slice” generally represents RAN slicing or a RAN slice unless specifically indicated.

Generally, according to different requirements of users for services, communication services can be classified into: Ultra-Reliable Low-Latency Communication (uRLLC), Enhanced Mobile Broadband (eMBB), general data services (for example, E-mail), and Massive Machine Type Communication (mMTC), etc.

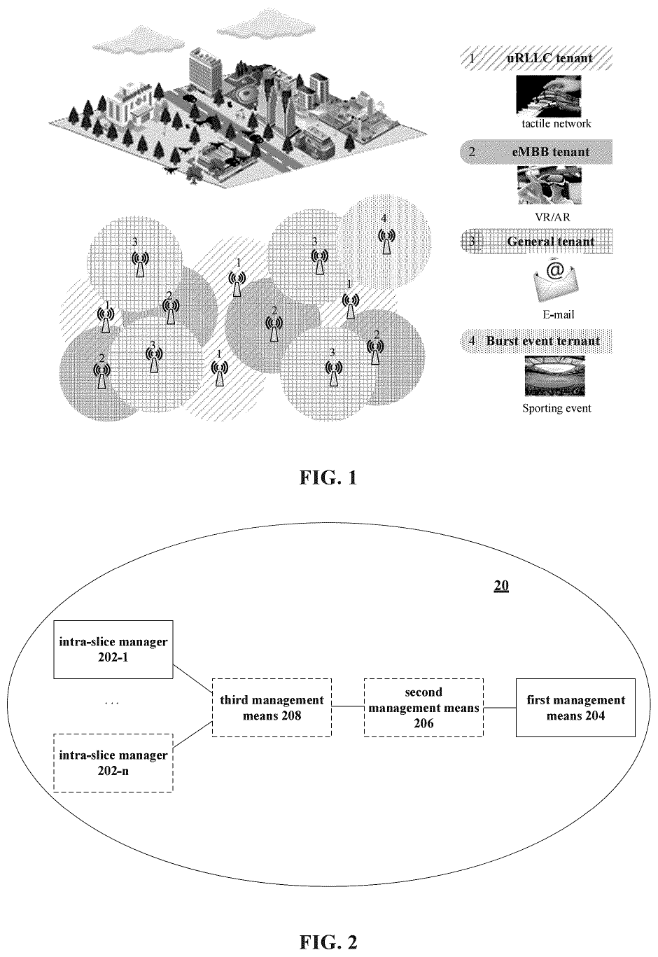

FIG. 1 illustrates a scenario of a wireless communication system in a city. As shown in FIG. 1, when the wireless communication system is initialized, corresponding RAN slices are allocated respectively for a uRLLc tenant, an eMBB tenant, and a general tenant involved in the scenario. Each RAN slice is generally allocated with corresponding spectrum resources.

Conventionally, dedicated spectrum resources are allocated to each RAN slice to ensure spectrum isolation among RAN slices, thereby avoiding interference among the RAN slices due to spectrum resource overlap. However, such a solution of spectrum resource isolation among the RAN slices results in a reduction in spectrum utilization. In a background of increasingly shortage of spectrum resources (for example, 5G and B5G in particular), such a solution of low spectrum utilization often results in difficulty in satisfying the requirement of RAN slices for spectrum resources, for example, resulting in the spectrum resources allocated to the RAN slices being insufficient to cope with the load of the RAN slices. Therefore, there is a need for a solution that can improve spectrum utilization while avoiding interference among the RAN slices (i.e., maintaining isolation performance among the RAN slices).

On the other hand, when the network changes dynamically, for example, as shown in FIG. 1, when a burst event such as a sporting event occurs, the RAN slices can be dynamically added, deleted, or modified. The addition, deletion, or modification of the RAN slices often requires reconfiguration of the spectrum resources of the RAN slices, resulting in an operation with greater complexity and greater time/economic cost. Therefore, there is a need for a solution of reducing complexity of reconfiguration of spectrum resources as much as possible with the support of flexible adjustment of RAN slices.

FIG. 2 schematically illustrates a schematic diagram of a configuration of a system for wireless communication according to an embodiment of the present disclosure.

As shown in FIG. 2, a system 20 for wireless communication according to the present disclosure can comprise at least one or more intra-slice managers 202-1 to 202-n (which can be uniformly noted as 202 hereinafter) and a first management means 204. Furthermore, the system 20 can further optionally comprise a second management means 206 and a third management means 208 that are depicted in dashed lines, and other appropriate devices not shown. The terms “intra-slice manager”, “first management means”, “second management means” and “third management means” can, herein, all correspond to the network element devices (software/virtualized devices/modules, distributed devices/modules or entity hardware devices) in the core network described above. It should be noted that although the embodiments of the present disclosure are described below primarily based on the communication system comprising the “intra-slice manager”, “first management means”, “second management means”, and “third management means”, the description can be correspondingly extended to the case of a communication system comprising any other type of network element devices. In particular, for 5G/B5G, the “first management means”, “second management means”, and “third management means” can correspond to function entities specified in the corresponding 3GPP standards. For example, the “first management means” can correspond to a Network Slice Subnet Management Function (NSSMF), the “second management means” can correspond to a Network Slice Management Function (NSMF), and the “third management means” can correspond to a Communication Service Management Function (CSMF). Of course, these management devices can also correspond to other appropriate function entities as appropriate, as long as corresponding functions described below can be realized.

Furthermore, the system for wireless communication according to the embodiment(s) of the present disclosure is described herein by taking the intra-slice manager, the first management means, and optionally the second management means and the third management means as examples. However, the system for wireless communication according to the present disclosure can comprise more or fewer devices.

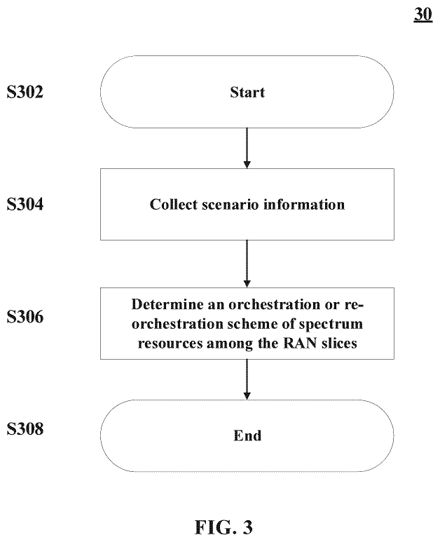

Specific operations of the devices in the system 20 according to the present disclosure will be described in detail below with reference to FIG. 3.

FIG. 3 schematically illustrates a first conceptual operation flow 30 of a method for a system for wireless communication according to an embodiment of the present disclosure. For example, corresponding operations of the first conceptual operation flow 30 can be performed by respective devices in the system 20 for wireless communication according to the present disclosure.

As described above, there is a need for a solution that can improve spectrum utilization while avoiding interference among the RAN slices (i.e., maintaining isolation performance among the RAN slices). In practice, the use of overlapping spectrum resources does not necessarily result in the interference among the RAN slices. For example, between two RAN slices, there may be interference among only some of the base stations. Therefore, by appropriately setting an overlap degree (in other words, a sharing degree at which spectrum resources can be shared among the RAN slices) of the spectrum resources among the RAN slices, it is possible to improve the spectrum utilization while avoiding the interference among the RAN slices. The method shown in FIG. 3 gives an example scheme for orchestrating or re-orchestrating resources among RAN slices by considering the overlap degree of the spectrum resources among the RAN slices.

The first conceptual operation flow 30 starts at S302.

At S304, scenario information of a corresponding RAN slice of a plurality of RAN slices in a wireless network can be collected by at least one of the one or more intra-slice managers 202 shown in FIG. 2. Such scenario information can be used for determining at least the following information: an interference relationship between RAN slices, a RAN slice priority, and a RAN slice spectrum resource requirement. Advantageously, the interference relationship between RAN slices that is determined based on the scenario information can be used for determining a degree at which spectrum resources of any of the RAN slices in the wireless network can overlap with spectrum resources of other RAN slices. In other words, the interference relationship between RAN slices can be used for determining a degree at which any of the RAN slices in the wireless network can share spectrum resources with other RAN slices (for example, the quantity of shared/overlapped channels).

At S306, an orchestration or re-orchestration scheme of spectrum resources among the plurality of RAN slices can be determined by the first management means 204 shown in FIG. 2 based on the scenario information. For example, the first management means 204 can determine the orchestration or re-orchestration scheme of spectrum resources among the plurality of RAN slices directly or indirectly based on the interference relationship between RAN slices, the RAN slice priority and the RAN slice spectrum resource requirement that are determined according to the scenario information. According to the present disclosure, the interference relationship between RAN slices, the RAN slice priority and the RAN slice spectrum resource requirement can be determined by any one or more of the devices 202 to 208 in the system 20 according to the scenario information as appropriate. This will be described below in detail.

According to the present disclosure, the orchestration or re-orchestration scheme of spectrum resources among the plurality of RAN slices comprises a first characteristic and quantity of spectrum resources to be allocated to at least one RAN slice of the plurality of RAN slices. For example, the first characteristic of the spectrum resources can at least indicate the type of the spectrum resources as follows: a spectrum resource not allocated to any RAN slice, a spectrum resource allocated to a RAN slice but not yet used by the RAN slice, and a spectrum resource capable of overlapping with spectrum resources allocated to a RAN slice.

The first conceptual operation flow 30 ends at S308.

The solution for wireless communication according to the present disclosure has been briefly described above in combination with FIGS. 2 and 3. Hereinafter, the operations in FIG. 3 will be described in detail.

According to the present disclosure, the scenario information can at least indicate one or more of the following: a base station position, base station transmit power, a spectrum resource requirement of abase station and a communication service requirement, wherein the spectrum resource requirement of the base station can be information directly indicating the amount (such as the number of channels required to serve its users) of spectrum resources required by the base station, or can also be information indicating the capacity, number, and etc. of the base station; and the communication service requirement can be information indicating a communication service type (such as uRLLC, eMBB, and mMTC) that the RAN slice is targeted at, or the communication service requirement can also be information indicating a communication requirement such as latency, reliability, QoS, rate, and the like.

Such scenario information can be received by the intra-slice manager in the system 20 as shown in FIG. 2. The system 20 according to the present disclosure can comprise one or more intra-slice managers. In the case where the system 20 comprises only one intra-slice manager, the intra-slice manager can collectively collect the scenario information of the RAN slices in the wireless network. In the case where the system 20 comprises a plurality of intra-slice managers, each intra-slice manager can manage one corresponding RAN slice respectively, and collect the scenario information of the RAN slice. Furthermore, in the case where the system 20 comprises the plurality of intra-slice managers, at least one intra-slice manager of the plurality of intra-slice managers can collectively manage a portion of the RAN slices in the wireless network, and collect scenario information corresponding to the portion of the RAN.

According to the present disclosure, the scenario information can be processed to determine the interference relationship between RAN slices, the RAN slice priority and the RAN slice spectrum resource requirement, so as to further determine the orchestration or re-orchestration scheme of spectrum resources among the plurality of RAN slices.

The interference relationship between RAN slices can be determined according to the base station position and the base station transmit power included in the scenario information. For example, the interference relationship between RAN slices can be represented by an inter-slice interference overlap matrix, wherein each item in the inter-slice interference overlap matrix can represent, for example, a proportion of the number of base stations for which interference with slice j exists in slice i to the total number of base stations in slice i, i.e.,

$$\frac{\begin{matrix}the number of base stations for which \\ interference with slice j exists in slice i\end{matrix}}{the total number of base stations in slice i} .$$

For example, if power of a signal from base station b of slice j that is detected at base station a of slice i is greater than a predetermined threshold, it can be determined that there is interference between base station a of slice i and base station b of slice j. It should be noted that, in order to more accurately determine whether there is interference between base stations, in addition to considering the base station position and the base station transmit power, other parameters such as spectrum and bandwidths used by the base stations can be further considered.

The RAN slice priority can be determined according to the communication service requirement included in the scenario information. For example, the RAN slice priority can be determined based on the communication service type, for example, a communication service type with a higher requirement for communication quality, such as uRLLC, can be allocated a higher RAN slice priority. For another example, the RAN slice priority can be determined based on information indicating a communication requirement such as latency, reliability, QoS, rate. For example, a RAN slice with a higher requirement for latency, reliability, QoS, or rate can be allocated a higher priority. Furthermore, the scenario information can further include information directly indicating the RAN slice priority.

The RAN slice spectrum resource requirement can be determined according to the spectrum resource requirement of the base station included in the scenario information. For example, the amount of spectrum resources required by a RAN slice can be determined according to the amount (for example, the number of channels, or indicated base station capacity) of spectrum resources required by base stations in the RAN slice and the number of the base stations. In addition, the scenario information can also include information directly indicating the RAN slice spectrum resource requirement.

According to the present disclosure, the scenario information can be processed by any suitable device of the devices 202 to 208 in the system 20 as shown in FIG. 2 to determine the interference relationship between RAN slices, the RAN slice priority and the RAN slice spectrum resource requirement.

For example, any suitable device of the devices 202 to 208 in the system 20 can process the scenario information to a certain degree to extract one or more of the interference relationship between RAN slices, the RAN slice priority and the RAN slice spectrum resource requirement, or extract intermediate information for extracting one or more of the interference relationship between RAN slices, the RAN slice priority and the RAN slice spectrum resource requirement, and transmit result information obtained by the processing together with the original scenario information required for obtaining the interference relationship between RAN slices, the RAN slice priority and the RAN slice spectrum resource requirement to other device(s) for further processing. For example, the intra-slice manager can transmit the original or processed scenario information to the third management means (for example, CSMF specified in the 3GPP standard). The third management means can further process the received information, and transmit the processed information to the second management means (for example, NSMF specified in the 3GPP standard). Similarly, the second management means can further process the received information, and transmit the processed information to the first management means (for example, NSSMF specified in the 3GPP standard).

In the present disclosure, there is no special limitation on what processing is performed on the scenario information by which device in the system 20, as long as the first management means can finally obtain the interference relationship between RAN slices, the RAN slice priority, and the RAN slice spectrum resource requirement. For example, in the case where there is only one intra-slice manager in the system 20, the collected scenario information of the slices even can be directly processed by the intra-slice manager to obtain the interference relationship between RAN slices, the RAN slice priority, and the RAN slice spectrum resource requirement, and the obtained information can be transmitted to the first management means via or without forwarding by the third/second management means. For another example, one or more intra-slice managers in the system 20 may not perform any processing on the scenario information, but processing on the scenario information is performed by one or more of the third management means, the second management means and the first management means, to obtain the interference relationship between RAN slices, the RAN slice priority and the RAN slice spectrum resource requirement.

The scenario information and the processing on the scenario information have been described in detail, and hereinafter, how to determine the orchestration or re-orchestration scheme of spectrum resources among the plurality of RAN slices will be described in detail.

In the present disclosure, if it is allowable (for example, in the case of not causing interference among the RAN slices), spectrum resources are enabled to be shared among the RAN slices, that is, the spectrum resources can be allocated among the plurality of RAN slices with overlap, thereby improving the spectrum utilization as much as possible with finite spectrum resources, and in turn satisfying the requirements of the RAN slices for the spectrum resources as much as possible (for example, satisfying the number of channels required by the RAN slices).

In practice, generally the spectrum resources may not be shared among the RAN slices without limitation, since excessive spectrum resource overlap may result in the interference among the RAN slices and/or may result in failure in satisfying security requirements of the RAN slices. Therefore, a degree at which a RAN slice allows spectrum resources to be shared with other RAN slices needs to be considered. In the present disclosure, a parameter “inter-slice sharing factor” is introduced to indicate a degree at which a RAN slice is capable of sharing spectrum resources with other RAN slices. For example, the inter-slice sharing factor can represent a proportion of the number of channels that a RAN slice can share with other RAN slices to the total number of channels owned by the RAN slice. By setting a value of the inter-slice sharing factor, a degree of spectrum isolation among RAN slices can be controlled. The smaller the value of the inter-slice sharing factor is, the lower the degree at which the RAN slice can share the spectrum resources with the other RAN slices is.

According to the present disclosure, the inter-slice sharing factor can be determined by any suitable device of the devices 202 to 208 in the system 20 based on the scenario information. In particular, the inter-slice sharing factor can be determined by the second management means 206 (for example, NSMF specified in the 3GPP standard), and the determined inter-slice sharing factor is transmitted to the first management means 204 (for example, NSSMF specified in the 3GPP standard) for the first management means 204 to determine the orchestration or re-orchestration scheme of spectrum resources among the plurality of RAN slices.

A first sharing factor for the at least one RAN slice among the plurality of RAN slices can be determined based on the communication service requirement indicated by the scenario information; a second sharing factor for any two RAN slices of the plurality of RAN slices can be determined based on the interference relationship between RAN slices determined from the scenario information; and for any two RAN slices of the plurality of RAN slices, the inter-slice sharing factor for the two RAN slices is determined based on a minimum value of the first sharing factor and the second sharing factor.

Specifically, the first sharing factor can represent a spectrum resource sharing degree required by a RAN slice based on a service type it targets. For a service with a higher security/communication quality requirement, a smaller first sharing factor can be set. For example, a RAN slice targeting uRLLC can require higher security, and therefore a smaller first sharing factor can be set for the RAN slice. The first sharing factor can, for example, represent a spectrum resource sharing degree subjectively required by a RAN slice. A value interval of the first sharing factor can be between 0 and 1.

The second sharing factor can depend on interference objectively present among base stations of the RAN slices. The second sharing factor can, for example, represent a degree at which spectrum resource can be shared objectively. The second sharing factor can be determined according to the inter-slice interference overlap matrix described above. Specifically, a second sharing factor between slice i and slice j can be determined as:

$${α}_{ij}^{2} = \frac{\begin{matrix}the total number of base stations in slice i - \\ the number of base stations for which \\ interference with slice j exists in slice i\end{matrix}}{the total number of base stations in slice i} .$$

For the slice i and the slice j, the inter-slice sharing factor can be determined as a minimum value between the first sharing factor αᵢⱼ¹ and the second sharing factor αᵢⱼ², i.e., αᵢⱼ=min{αᵢ¹,αᵢⱼ²}. For the network where there are the plurality of RAN slices, there can be a table representing inter-slice sharing factors. Table 1 shows an inter-slice sharing factor table for a network comprising 3 RAN slices.

TABLE 1

| | slice 1 | slice 2 | slice 3 |
|---|---|---|---|
| slice 1 | 1 | 0.5 | 0.2 |
| slice 2 | 0 | 1 | 0 |
| slice 3 | 0.5 | 0.3 | 1 |

As shown in Table 1, a proportion of spectrum resources that slice 1 can share with slice 2 is 0.5, i.e. 50% of spectrum resources that are allocated to the slice 1 can be shared with the slice 2, while a proportion of spectrum resources that the slice 2 can share with the slice 1 is 0. In other words, αᵢⱼ and αⱼᵢ can be different values, and when determining the orchestration or re-orchestration scheme of spectrum resources among the plurality of RAN slices, as described below, the two values of αᵢⱼ and αⱼᵢ will be both considered to satisfy the requirements of both the slice i and the slice j for the spectrum resource sharing degree.

According to the present disclosure, the orchestration or re-orchestration scheme of spectrum resources among the plurality of RAN slices is determined with comprehensive consideration of the inter-slice sharing factor, the RAN slice priority, the RAN slice spectrum resource requirement, and the total quantity of the spectrum resources available for the network. Hereinafter, a specific operations for determining the orchestration scheme of spectrum resources among the plurality of RAN slices will be described first. For example, initially, that is, when the RAN slices have not yet been allocated with any spectrum resources, the orchestration of the spectrum resources among the RAN slices can be performed.

Which device determines the orchestration does not constitute a limitation to the present disclosure, and the orchestration scheme of spectrum resources can be determined by any appropriate device (shown or not shown in FIG. 2) as appropriate. For simplicity, as a unified example herein, the orchestration scheme of spectrum resources among the plurality of RAN slices is determined by the first management means 204 (for example, NSSMF specified in 3GPP) shown in the system 20 of FIG. 2.

The determination of the orchestration scheme of spectrum resources among the plurality of RAN slices can be regarded as an optimization problem as follows: how to satisfy the spectrum resource requirements of the RAN slices as much as possible with the satisfaction of the requirements of the RAN for the spectrum resource sharing degree, and to make a spectrum resource requirement of a RAN slice with a higher priority be satisfied to a higher degree, and to make a spectrum resource requirement of a RAN slice allowing a higher spectrum resource sharing degree be satisfied to a higher degree (in other words, in the case of same other conditions (for example, priorities), comparing to a RAN slice allowing a lower spectrum resource sharing degree, to allocate more spectrum resources to a RAN slice allowing a higher spectrum resource sharing degree, so as to enable its spectrum resource requirement to be satisfied more. Because this can provide more spectrum resources that can be shared, thereby improving the spectrum resource utilization).

For the first management means 204 that determines the orchestration of spectrum resources among the plurality of RAN slices, input X₁ of the above optimization problem can be represented as X₁=[α, P, N′, N_{RB}], and the output thereof can be at least a matrix H₁ representing an allocation scheme of spectrum resources among the RAN slices, (for example, the matrix can indicate how many spectrum resources (for example, how many channels) are allocated to each RAN slice, respectively), where α is a matrix representing the inter-slice sharing factors (for example, a matrix corresponding to items of the inter-slice sharing factor table), P is a matrix representing the RAN slice priorities, N′ is a matrix representing the RAN slice spectrum resource requirements (for example, representing the number of channels required by the RAN slices), and N_{RB} represents the total quantity of spectrum resources available for the network (for example, the total number of channels available in the network). For convenience of description, the channel is taken as an example for representing the spectrum resource hereinafter, and the quantity of RAN spectrum resources can be represented as the number of channels.

Specifically, the above optimization problem can be represented as the following equation (1):

$${max}_{{H}_{1}} {\sum }_{s} ( {p}_{s} \frac{{N}_{s}}{{N}_{s}^{′}} + {\sum }_{j \neq s}^{s} \frac{{N}_{sj}}{{N}_{s}} ) \qquad equation ( 1 )$$

$$s . t . {N}_{s} \leq {N}_{s}^{′}$$

$${N}_{sj} \leq min \{ {α}_{sj} {N}_{s} , {α}_{js} {N}_{j} \}$$

where pₛ represents the priority of slice s; Nₛ represents the number of channels allocated to slice s; Nₛ′ is the number of channels required by slice s; N_{s,j} represents the number of channels shared between slice s and slice j; αₛⱼ represents an inter-slice sharing factor of slice s and slice j (i.e., representing a proportion of channels that slice s can share with slice j).

In particular, it can be appreciated according to the above equation that, N_{s,j} is a value obtained with the consideration of the respective requirements of slice s and slice j for the channel sharing degrees. For example, referring to the values of the sharing factors in the Table 1, the proportion of channels that slice 1 can share with slice 2 is 0.5, while the proportion of spectrum resources that slice 2 can share with slice 1 is 0, so that the number of channels shared between slice 1 and slice 2 is 0 regardless of the values of N₁ and N₂ for slice 1 and slice 2.

Furthermore, it can be appreciated according to the above equation that, in order to maximize the value of

$${\sum }_{j \neq s}^{s} \frac{{N}_{sj}}{{N}_{s}}$$

so as to obtain the maximized

$${\sum }_{s} ( {p}_{s} \frac{{N}_{s}}{{N}_{s}^{′}} + {\sum }_{j \neq s}^{s} \frac{{N}_{sj}}{{N}_{s}} ) ,$$

since αₛⱼ and αⱼₛ are the inter-slice sharing factors determined according to the scenario information, a spectrum resource requirement of a RAN slice with a larger inter-slice sharing factor should be made satisfied to a higher degree (for example, the number of channels allocated to the RAN slice is made equal to the number of channels required by the RAN slice as far as possible), so that the value of N_{s,j} is maximized. In other words, the more the channels allocated to the RAN slice with the larger inter-slice sharing factor are, the more the channels capable being shared determined based on the inter-slice sharing factor are, and further, more allocable channels can be brought to the entire network. Therefore, for one thing, the requirements of the RAN slices for the number of channels can be satisfied to a higher degree, and for another thing, the spectrum resource utilization can be improved.

Equation (1) can be solved by means of an Artificial Intelligence (AI) algorithm. Equation (1) can be solved using any suitable AI algorithm to determine the orchestration scheme of spectrum resources among the plurality of RAN slices. Herein, the deep Q-network (DQN) algorithm is taken as an example for explanation. It should be understood that DQN algorithm is merely an example and does not constitute a limitation to the solution of the present disclosure.

DQN, as a reinforcement learning algorithm, has a basic principle of training a neural network by using repeated iteration and finally making the algorithm converged. The process of solving the optimization problem described in the above equation (1) using DQN can be briefly summarized as follows: in each iteration of the algorithm, making one action according to the current state of the network, and calculating a reward value brought by the action; training the neural network by using the reward value, wherein if a reward value brought by a certain action is larger, an action similar to the action will be made with a higher probability in a similar state when running the whole algorithm next time; and after several rounds of iterative training, the algorithm converging to an orchestration scheme of spectrum resources that maximizes

$${\sum }_{s} ( {p}_{s} \frac{{N}_{s}}{{N}_{s}^{′}} + {\sum }_{j \neq s}^{s} \frac{{N}_{sj}}{{N}_{s}} ) .$$

Here, a state of the DQN algorithm can be designed as: [μ, N], where

$$μ = [ {μ}_{1} , {μ}_{2} , … , {μ}_{s} ] , {μ}_{s} = \{ \begin{matrix}1 , & if allocation to slice s has already been performed \\ 0 , & if allocation to slice s has not yet been performed\end{matrix}$$

$$N = [ {N}_{1} , {N}_{2} , … , {N}_{s} ] ;$$

the action to be made by DQN algorithm each iteration can be represented as deciding which RAN slice to be allocated spectrum resources in the current state; furthermore, the reward value of DQN algorithm can be designed as

$${\sum }_{s} ( {p}_{s} \frac{{N}_{s}}{{N}_{s}^{′}} + {\sum }_{j \neq s}^{s} \frac{{N}_{sj}}{{N}_{s}} ) .$$

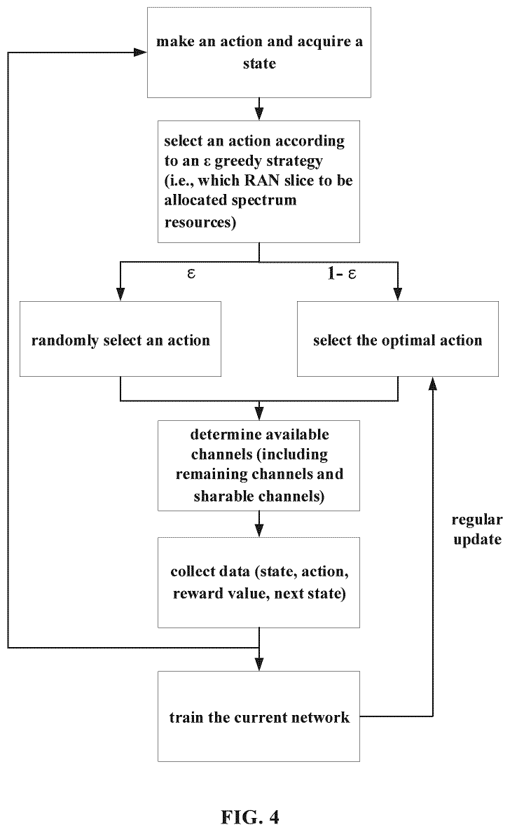

Specifically, FIG. 4 shows an exemplary operating process of the DQN algorithm.

At the beginning of each iteration, an agent running DQN algorithm determines which RAN slice to be allocated spectrum resources in the current state. Here, an action can be selected according to an greedy strategy. That is, the agent selects an action based on a probability ε, specifically, randomly selects one RAN slice with the probability of to allocate spectrum resources, and selects the optimal action based on the trained data with a probability of 1−ε. It should be noted that as the number of iterations increases, ε can become smaller and smaller, thereby more tending to select the optimal action based on the trained data.

After determining the RAN slice (hereinafter referred to as the current RAN slice) to which spectrum resources are to be allocated, the agent needs to query available spectrum resources in the current state, which include, for example, remaining spectrum resources not yet allocated and spectrum resources have been allocated but sharable with the current RAN slice. The sharable spectrum resources are determined by the state [μ, N] and the sharing factor α. After allocating spectrum to the current RAN slice, the agent will update the state and calculate the reward value, and store the relevant data (for example, the current state, the action taken this time, the reward value brought by the action, and a state after the action is made (i.e., a next state), etc.) into an experience pool for training and updating the neural network. After updating the state, the agent performs a next iteration, i.e., determines a RAN slice to which spectrum resources are to be allocated, and performs a corresponding subsequent operations. After allocation to all the RAN slices is performed, one execution of the algorithm is completed. After a certain cutoff condition (for example, a certain degree of convergence) or number of executions is reached, the algorithm terminates.

The specific operations of determining the orchestration scheme of spectrum resources among the plurality of RAN slices has been described above. It is to be noted that, although the orchestration scheme of spectrum resources is described above by taking the initial situation as an example, the above operations are not limited to the initial situation, and when the spectrum resources are re-arranged, firstly, how many spectrum resources are allocated to each RAN slice can be determined according to the above specific operations, and then (as will be described hereinafter) which type of spectrum resources is allocated to each RAN is determined.

Advantageously, since the solution of the present disclosure considers to make spectrum resources partially overlap among the plurality of RAN slices according to the degrees (i.e., sharing factors) accepted by the RAN slices, the spectrum satisfaction of the RAN slices is improved, and the spectrum utilization is improved.

As described above, when the network changes dynamically, it may need to dynamically add, delete, or modify the RAN slices. That is, re-orchestration of spectrum resources among the plurality of RAN slices may be involved. In the re-orchestration of spectrum resources, in addition to considering allocating partially overlapping spectrum resources to the RAN slices to improve the spectrum utilization and spectrum satisfaction as described above, in particular, the solution of the present disclosure also focuses on how to reduce reconfiguration complexity of spectrum resources in the re-orchestration of spectrum resources. This will be described in detail below.

According to the present disclosure, reducing the reconfiguration complexity of spectrum resources can be considered from two aspects.

In a first aspect, the network (for example, network traffic) is, in fact, always dynamically changing. If the orchestration scheme of spectrum resources is updated among the RAN slices as soon as the network traffic changes, this will cause excessive frequent reconfiguration operations, thereby increasing the reconfiguration complexity of spectrum resources in terms of signaling, operations, etc., and further causes waste of time, and economic costs. Therefore, the present disclosure considers reducing the reconfiguration complexity of spectrum resources by limiting timing which triggers the re-orchestration of spectrum resources. The present disclosure limits the triggering of the re-orchestration of spectrum resources among the plurality of RAN slices by introducing a parameter “slice maximum capacity”.

Specifically, the slice maximum capacity can reflect a maximum number of users that the RAN slice can serve. When a load of a certain RAN slice in the network exceeds the slice maximum capacity of the RAN slice, spectrum resources allocated to the RAN slice may be insufficient to cope with the number of users currently in the RAN slice, and therefore, the re-orchestration of spectrum resources among the RAN slices can be triggered. In other words, the re-orchestration of spectrum resources is performed in response to the load of the RNA slice exceeding the slice maximum capacity of the RAN slice.

A slice maximum capacity of at least one RAN slice among the plurality of RAN slices can be determined at least based on an interference relationship inside a RAN slice and the quantity of spectrum resources to be allocated to the at least one RAN slice among the plurality of RAN slices. Specifically, the slice maximum capacity Cₘₐₓ^{s} of RAN slice s can be determined by the following equation (2)

$${C}_{max}^{s} = \text{?} \cdot \overline{c} \cdot {η}_{s} \qquad equation ( 2 )$$

$$\text{?} \text{indicates text missing or illegible when filed}$$

where Nₛ represents the quantity of spectrum resources (for example, the number of channels) allocated to slice s, N̅_̅{̅b̅}̅′̅ is an average spectrum resource requirement (for example, an average channel requirement) of base stations in slice s, c̅ is an average number of users that can be served by a single base station in the slice s, and ηₛ is an intra-slice maximum sharing proportion (i.e., a maximum sharing proportion of spectrum resources among the base stations in slice s) determined according to an interference relationship inside slice s, and more specifically, according to a base station interference overlap matrix I in slice s.

The interference relationship inside a RAN slice can be determined based on the scenario information. More specifically, a matrix of the interference relationship among base stations in the RAN slice, i.e., the base station interference overlap matrix I, can be calculated according to information such as the base station position and transmit power indicated by the scenario information, wherein if it is determined that there is interference between base station i and base station j according to the information such as the base station position and transmit power, an item Iᵢⱼ=1 in the base station interference overlap matrix I, otherwise Iᵢⱼ=0.

Further, the intra-slice maximum sharing proportion can be determined by the following operations:
performing binary negation of the interference overlap matrix I;
finding out, in the matrix after the binary negation of the matrix I, fully-connected sets having no same elements mutually, and mutually independent nodes, F₁, F₂, . . . , F_{Z};
combining these fully-connected sets and the mutually independent nodes to form a set [symbol] , i.e. [symbol] ={F₁, F₂, . . . , F_{Z}|∀F′∈ [symbol] , F″∈ [symbol] , F′∩F″=Ø}; and
determining a ratio of the total number B of base stations to the total number Z of the above fully-connected sets and the independent nodes as the maximum sharing proportion ηₛ, i.e.

$${η}_{s} = \frac{B}{Z} .$$

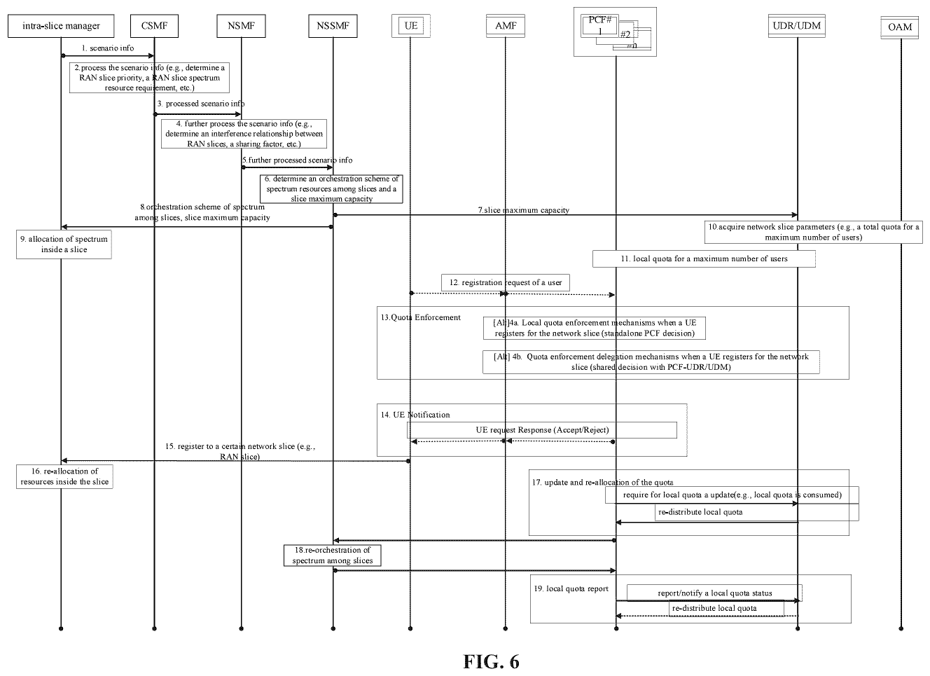

According to the present disclosure, the slice maximum capacity of each RAN slice can be determined each time the orchestration/re-orchestration scheme spectrum resources is determined. For example, the slice maximum capacity of each RAN slice is determined, whether for the first orchestration or any re-orchestration of spectrum resources. For another example, in the case where the re-orchestration of spectrum resources does not cause the quantity of spectrum resources to be allocated to certain one or more RAN slices, the slice maximum capacity of the one or more RAN slices may not be re-determined. Moreover, an entity for determining a slice maximum capacity (for example, the first management means 204 in the system. 20 of FIG. 2, but the slice maximum capacity can also be determined by another appropriate entity) can transmit the determined slice maximum capacity of the at least one RAN slice to the intra-slice manager 202 and an entity recording changes in a network slice load in the wireless network. The entity recording changes in a network slice load can, when detecting that a load of a certain RAN slice exceeds a slice maximum capacity corresponding to the slice, notify an entity performing orchestration/re-orchestration of spectrum resources (for example, the first management means 204) to trigger the re-orchestration of spectrum resources among the RAN slices. According to the present disclosure, as described in detail below with reference to FIGS. 6 to 8, the entity recording changes in a network slice load comprise one or more of entities realizing the following functions: Unified Data Repository (UDR)/Unified Data Management (UDM), Operation Administration and Maintenance (OAM), Network Slice Quota (NSQ) or Network Slice Selection Function (NSSF).

Hereinafter, a second aspect of reducing the reconfiguration complexity of spectrum resources will be described. A process of re-allocation of spectrum resources allocated to a certain RAN slice to another RAN slice brings complexity in terms of signaling, operations, etc. Thus, in addition to reducing unnecessary triggers for the re-orchestration of spectrum resources, the present disclosure further considers making the quantity of spectrum resources which have been allocated to existing RAN slices be re-allocated to other RAN slices as little as possible after the re-orchestration of spectrum resources being triggered. In other words, the present disclosure considers reducing the quantity of the following spectrum resources as little as possible: spectrum resources having been allocated to a certain RAN slice and needing to be re-allocated to other RAN slices.

Specifically, in determining the re-orchestration scheme of spectrum resources among the plurality of RAN slices, it can be considered to reduce the quantity of spectrum resources having been allocated to a certain RAN slice and needing to be re-allocated to another RAN slice. In determining the re-orchestration scheme of spectrum resources among the plurality of RAN slices, the above equation (1) can be modified to the following equation (3) to achieve the purpose.

$${max}_{{H}_{1}} ( {\sum }_{s} ( {p}_{s} \frac{{N}_{s}}{{N}_{s}^{′}} + {\sum }_{j \neq s}^{s} \text{?} ) - {γ}_{1} \frac{{\sum }_{n}^{{N}_{RB}} {ξ}_{n}^{1}}{{N}_{RB}} ) \qquad equation ( 3 )$$

$$s . t . {N}_{s} \leq {N}_{s}^{′}$$

$${N}_{sj} \leq min \{ {α}_{sj} {N}_{s} , {α}_{js} {N}_{j} \}$$

$$\text{?} \text{indicates text missing or illegible when filed}$$

where an item

$${γ}_{1} \frac{{\sum }_{n}^{{N}_{RB}} {ξ}_{n}^{1}}{{N}_{RB}}$$

can represent a degree of proportion of the quantity of spectrum resources allocated to existing RAN slices and to be re-allocated to other RAN slices to total spectrum resources, where γ₁ represents a reconfiguration weight, a value of which can be between 0 and 1; ξₙ¹ represents the number of re-allocations of the spectrum resource n (for example, channel n) allocated to the existing RAN slices to other RAN slices; and N_{RB} represents the quantity of the total spectrum resources (for example, the number of total channels).

Specifically, while determining the orchestration scheme of spectrum resources making

$${\sum }_{s} ( {p}_{s} \frac{{N}_{s}}{{N}_{s}^{′}} + {\sum }_{j \neq s}^{s} \text{?} )$$

$$\text{?} \text{indicates text missing or illegible when filed}$$

as big as possible according to the operations described above with reference to Equation (1),

$${γ}_{1} \frac{{\sum }_{n}^{{N}_{RB}} {ξ}_{n}^{1}}{{N}_{RB}}$$

can be made as small as possible by determining a first characteristic of the spectrum resources to be allocated to each RAN slice, so that the entire equation (3) is made as big as possible. The first characteristic of the spectrum resources can, for example, at least indicate the type of spectrum resources as follows: a spectrum resource not allocated to any RAN slice, a spectrum resource allocated to a RAN slice but not yet used by the RAN slice, and a spectrum resource capable of overlapping with spectrum resources allocated to a RAN slice. A general principle of determining the first characteristic of the spectrum resources can be to allocate the spectrum resources in the following order as far as possible: spectrum resources not allocated to any RAN slice, spectrum resources allocated to a RAN slice but not yet used by the RAN slice, and spectrum resources capable of overlapping with spectrum resources allocated to a RAN slice. In this way, spectrum resources having been allocated to RAN slices can be used as few as possible, thereby introducing the readjustment of the spectrum resources among the RAN slices as few as possible, further reducing the reconfiguration complexity of spectrum resources, and greatly reducing the influence on the RAN slices to which the spectrum resources have been allocated in the re-orchestration of spectrum resources.

Here, in the case of considering reducing the reconfiguration complexity of spectrum resources, the first characteristic of the spectrum resources has been described by taking examples of the three types of spectrum resources, namely, a spectrum resource not allocated to any RAN slice, a spectrum resource allocated to a RAN slice but not yet used by the RAN slice, and a spectrum resource capable of overlapping with spectrum resources allocated to a RAN slice. However, it should be understood that the first characteristic of the spectrum resources is not limited to the above types of spectrum. For example, in determining the orchestration or re-orchestration scheme of spectrum resources among the RAN slices, which type of spectrum resources is allocated to each RAN slice can also be determined according to the communication service requirements and the like of the RAN slices. In this case, the first characteristic can further comprise other characteristics such as a frequency band corresponding to the spectrum resources, thereby performing targeted spectrum resource allocation for the RAN slices.

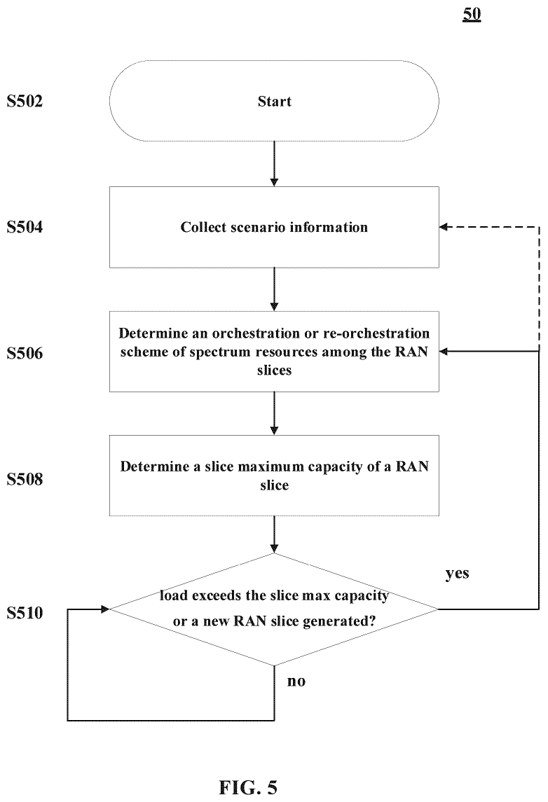

FIG. 5 schematically illustrates a second conceptual operation flow 50 of a method for a system for wireless communication according to an embodiment of the present disclosure, wherein the operation flow is, for example, applicable to the case of re-orchestration of spectrum resources. Similar to FIG. 3, corresponding operations of the second conceptual operation flow 50 can be performed by various devices in the system 20 for wireless communication according to the present disclosure.

Operations of S502 to S506 of the second conceptual operation flow 50 are similar to those of S302 to S306 of the first conceptual operation flow 30 described with reference to FIG. 3.

The difference is that at S506, since it is the re-orchestration of spectrum resources, as described in detail above, the re-orchestration of spectrum resources is performed while making the quantity of spectrum resources having been allocated to existing RAN slices be re-allocated to other RAN slices as little as possible. For example, how many spectrum resources (for example, how many channels) are to be allocated to each RAN slice, and which type (for example, unallocated, allocated but unused, and allocated and used but sharable) of spectrum resources is to be allocated to the RAN slice can be determined according to Equation (3).

At S508, as described above, a slice maximum capacity of a RAN slice is determined at least based on an interference relationship inside a RAN slice and the quantity of spectrum resources allocated to the RAN slice. The slice maximum capacity of each RAN slice can be determined, for example, by the first management means 204 in the system 20 of FIG. 2. In addition, the first management means 204 can further transmit the determined slice maximum capacity to an entity recording changes in a network slice load in the wireless network, so as to subsequently trigger the re-orchestration of spectrum resources. The first management means 204 can further transmit the determined slice maximum capacity to an intra-slice manager for the intra-slice manager to determine an allocation/re-allocation scheme of spectrum resources among base stations in the RAN slice. Although the step S508 is described here in the case applicable to the re-orchestration of spectrum resources, it can be understood that the above first conceptual operation flow 30 described with reference to FIG. 3 can also comprise an operation of determining and transmitting a slice maximum capacity that is similar to the S508 of the second conceptual operation flow 50.

At S510, if the entity recording changes in a network slice load in the wireless network detects that a load of a certain RAN slice exceeds a slice maximum capacity of the RAN slice, or a new RAN slice is generated in the wireless network due to burst communication or the like, the re-orchestration of spectrum resources is triggered. In this case, the scenario information can be re-collected and the re-orchestration scheme of spectrum resources can be determined as appropriate, or the re-orchestration scheme of spectrum resources can be directly determined if the scenario information is sufficient. If, as in the “No” branch of S510, it is not detected that a load of any RAN slice exceeds the slice maximum capacity of the RAN slice, or no new RAN slice is generated, no re-orchestration of spectrum resources is triggered.

The operations of determining the orchestration or re-orchestration scheme of spectrum resources among the plurality of RAN slices according to the present disclosure has been described in detail above. According to the present disclosure, since the use of spectrum resources sharable among the RAN slices is considered, the spectrum utilization and the spectrum resource satisfaction of the RAN slices can be improved. In addition, since the timing for triggering the re-orchestration of spectrum resources among the RAN slices is limited and the quantity of allocated spectrum resources needing to be adjusted among the RAN slices is limited, the reconfiguration complexity of spectrum resources among the RAN slices can be reduced as much as possible.

In practice, in addition to the need to allocate corresponding spectrum resources to the RAN slices, it is also needed to allocate corresponding spectrum resources to at least one base station (for example, each base station) in the RAN slice. This will be described in detail below.

According to the present disclosure, an allocation or re-allocation scheme of spectrum resources inside the RAN slice can be determined by any suitable device in the system 20 shown in FIG. 2. In particular, the allocation or re-allocation scheme of spectrum resources inside the RAN slice can be determined by the intra-slice manager.

In the case where an entity (for example, the intra-slice manager in FIG. 2) for determining an allocation/re-allocation scheme of spectrum resources inside a RAN slice and an entity (for example, the first management means in FIG. 2) for determining an orchestration/re-orchestration scheme of spectrum resources among RAN slices are not the same entity, information interaction can be performed between the above two entities to transfer information required for determining an allocation/re-allocation scheme of spectrum resources inside a slice, such as the first characteristic of spectrum resources and/or the quantity of spectrum resources allocated to the slice. For example, after the orchestration/re-orchestration scheme of spectrum resources within the RAN slices is determined by the first management means 204 in FIG. 2, the first management means 204 can transmit information indicating the first characteristic of spectrum resources allocated to each RAN slice and/or information indicating the quantity allocated to each RAN slice to corresponding one or more intra-slice managers, for the intra-slice manager to determine an allocation/re-allocation scheme of spectrum resources inside a slice managed by the intra-slice manager.

According to the present disclosure, an allocation or re-allocation scheme of spectrum resources inside a corresponding RAN slice can be determined at least based on the first characteristic and/or quantity of spectrum resources to be allocated to the corresponding RAN slice of the plurality of RAN slices, wherein an allocation or re-allocation scheme of spectrum resources inside one RAN slice comprises a second characteristic and quantity of spectrum resources to be allocated to at least one base station in the RAN slice. The second characteristic of the spectrum resources can at least indicate the type of spectrum resources as follows: a spectrum resource not allocated to any base station, a spectrum resource allocated to a base station but not yet used by the base station, and a spectrum resource capable of overlapping with spectrum resources allocated to a base station.

Hereinafter, specific operations of determining an allocation scheme of spectrum resources inside a RAN slice will be first described. For example, allocation of spectrum resources inside a RAN can be performed initially, that is, when no base station has been allocated any spectrum resource.

Specifically, the determination of an allocation scheme of spectrum resources inside a RAN slice can be regarded as the following optimization problem: how to satisfy spectrum resource requirements of base stations in the RAN slice as much as possible. Spectrum satisfaction of a base station can be considered from two aspects. For one thing, the more the spectrum resources are allocated to the base station, the higher the satisfaction is. In other words, the more the users the base station can serve with the allocated spectrum resources, the higher the satisfaction is. For another thing, the higher QoS the base station brings to the users by using the allocated spectrum resources or the higher economic benefit is generated, the higher the satisfaction is. For the latter, for example, spectrum resources with different first characteristics may bring different degrees of spectrum satisfaction to the base station.

More specifically, the above optimization problem can be represented as the following equation (4):

$${max}_{{H}_{2}} {\sum }_{b} ( \frac{{N}_{b}^{s}}{{N}_{b}^{′}} + {u}_{b} ) \qquad equation ( 4 )$$

$$s . t . {N}_{b}^{s} \leq {N}_{b}^{′}$$

$${N}_{b}^{s} \leq {N}_{s}$$

$${C}_{req}^{s} \leq {C}_{max}^{s}$$

where H₂ is a matrix representing an allocation scheme of spectrum resources among base stations of slice s (for example, the matrix can indicate how many spectrum resources (for example, how many channels) are allocated to each base station), N_{b}^{s} represents the quantity of spectrum resources (for example, the number of channels) allocated to a base station b of slice s; N_{b}^{l} represents the quantity of spectrum resources required by base station b; u_{b} represents a benefit value (for example, can reflect QoS or economic benefit, etc. as described above) brought after base station b being allocated the spectrum resources; Nₛ represents the quantity of total spectrum resources allocated to slice s; C_{req}^{s} represents a load (for example, the number of users) of slice s; Cₘₐₓ^{s} represents a slice maximum capacity of slice s.

Equation (4) can be solved by means of an Artificial Intelligence (AI) algorithm. Equation (4) can be solved using any suitable AI algorithm to determine an allocation scheme of spectrum resources among a plurality of base stations in one RAN slice. Herein, an ant colony optimization (ACO) algorithm is taken as an example for explanation. It should be understood that the ACO algorithm is merely an example and does not constitute a limitation to the solution of the present disclosure.

The ACO is a swarm intelligence algorithm, a principle of which is to simulate a method of ants searching for food to solve the optimization problem. A traditional ant colony algorithm is often used for a problem of searching for a shortest path. In an initial stage of the algorithm, the ants will be placed randomly on nodes, and the ants all need to traverse all the nodes. Each ant will release ‘pheromone’ on a path when walking, and a subsequent ant will perform path selection according to a pheromone concentration on the path. Eventually, almost all the ants will select a path with the highest pheromone concentration (i.e., the largest pheromone).

In the present disclosure, the basic idea of solving the optimization problem illustrated in the above equation (4) using the ACO algorithm can be briefly summarized as follows: taking base stations to be allocated spectrum resources inside the RAN slice as the nodes that the ants need to traverse, each ant needs to traverse all the nodes. Upon walking to one node, each ant allocates, to a base station represented by the node, currently available spectrum resources (for example, spectrum resources unallocated or unused, or spectrum resources allocated to a base station not interfering with the base station) as much as possible. In addition,

$${\sum }_{b} ( \frac{{N}_{b}^{s}}{{N}_{b}^{′}} + {u}_{b} )$$

can be used as the pheromone of the ACO algorithm. In this way, when all the ants have traversed all the nodes, an allocation scheme of spectrum inside the slice that maximizes

$${\sum }_{b} ( \frac{{N}_{b}^{s}}{{N}_{b}^{′}} + {u}_{b} )$$

can be obtained.

Specifically, after one ant has already traversed all the nodes, the ACO algorithm will calculate pheromone increment ΔP^{k} of path k walked by traversing nodes this time, and average the pheromone increments based on a total number B of the base stations in the slice, i.e.

$$\frac{Δ {P}^{k}}{B} ,$$

and take the average as a pheromone increment of each node on path k. A cumulative pheromone Pᵢⱼ^{k} between nodes i and j on path k can be calculated according to the following equation (5):

$${P}_{ij}^{k} = {P}_{ij}^{k - 1} + \frac{Δ {P}^{k}}{B} \qquad equation ( 5 )$$

where Pᵢⱼ^{k-1} is cumulative pheromone between node i and node j after (k−1)th path (for example, a path traveled by a previous ant). The cumulative pheromone between the nodes will affect selection of a subsequent ant for a path. Eventually, the ACO algorithm will converge to the allocation scheme of spectrum resources inside the RAN slice that maximizes

$${\sum }_{b} ( \frac{{N}_{b}^{s}}{{N}_{b}^{′}} + {u}_{b} ) .$$

The specific operation of determining the allocation scheme of spectrum resources inside the RAN slice has been described above. It is to be noted that, although the allocation scheme of spectrum resources is described above by taking the initial situation as an example, the above operations are not limited to the initial situation. In re-allocation of spectrum resources inside the slice, firstly, how many spectrum resources are allocated to each base station can also be determined according to the above specific operations, and then (as will be described hereinafter) which type of spectrum resources is allocated to each base station is determined.

Similar to the description made above with reference to the re-orchestration of spectrum resources among slices, in re-allocation of spectrum resources inside a slice, reduction of reconfiguration complexity of spectrum resources is also considered. Similar to the re-orchestration of spectrum resources among slices, it can also be considered that the reconfiguration complexity of spectrum resources inside the slice is reduced by making the quantity of spectrum resources which have been allocated to existing base stations be re-allocated to other base stations as little as possible. In other words, the present disclosure considers reducing the quantity of the following spectrum resources as much as possible: spectrum resources having been allocated to a certain base station and needing to be re-allocated to other base stations.

Specifically, in determining a re-allocation scheme of spectrum resources inside a RAN slice, it can be considered to reduce the quantity of spectrum resources having been allocated to a certain base station and needing to be re-allocated to another base station. In determining the re-allocation scheme of spectrum resources inside the RAN slice, the above equation (4) can be modified to the following equation (6) to achieve this purpose.

$${max}_{{H}_{2}} ( {\sum }_{b} ( \frac{{N}_{b}^{s}}{{N}_{b}^{′}} + {u}_{b} ) - {γ}_{2} \frac{{\sum }_{n}^{{N}_{s}} {ξ}_{n}^{2}}{{N}_{s}} ) \qquad equation ( 6 )$$

where an item

$${γ}_{2} \frac{{\sum }_{n}^{{N}_{s}} {ξ}_{n}^{2}}{{N}_{s}}$$

can represent a proportion of the quantity of spectrum resources allocated to a base station and to be re-allocated to other base stations to total spectrum resources allocated to slice s, where γ₂ represents an intra-slice reconfiguration weight, a value of which can be between 0 and 1; ξₙ² represents the number of re-allocations of spectrum resource n (for example, channel n) allocated to the base station to other base stations; and Nₛ represents a total quantity of spectrum resources allocated to slice s.

For example, while the allocation scheme of spectrum resources which makes

$${\sum }_{b} ( \frac{{N}_{b}^{s}}{{N}_{b}^{′}} + {u}_{b} )$$

be at big as possible is determined according to the operations described above with reference to Equation (4),

$${γ}_{2} \frac{{\sum }_{n}^{{N}_{s}} {ξ}_{n}^{2}}{{N}_{s}}$$

can be made as small as possible by determining the second characteristic of spectrum resources to be allocated to each base station, so that the entire equation (6) is made as big as possible. The second characteristic of spectrum resources can at least indicate the type of spectrum resources as follows: a spectrum resource not allocated to any base station, a spectrum resource allocated to a base station but not yet used by the base station, and a spectrum resource capable of overlapping with spectrum resources allocated to a base station. A general principle of determining the second characteristic of spectrum resources can be to allocate spectrum resources in the following order as far as possible: spectrum resources not allocated to any base station, spectrum resources allocated to a base station but not yet used by the base station, and spectrum resources capable of overlapping with spectrum resources allocated to a base station. In this way, spectrum resources having been allocated to base stations can be used as few as possible, thereby introducing readjustment of the spectrum resources among the base stations as few as possible, further reducing the reconfiguration complexity of spectrum resources, and in the re-allocation of spectrum resources, and greatly reducing the influence on the base stations to which the spectrum resources have been allocated.

The system for wireless communication and the method performed by the system according to the present disclosure have been described in detail above.

Hereinafter, three information flow examples in one specific embodiment of the present disclosure will be described in combination with FIGS. 6 to 8. In this embodiment, NSSMF acts as the first management means 204 in FIG. 2, NSMF acts as the second management means 206, and CSMF acts as the third management means 208 in FIG. 2. Furthermore, in this embodiment, an intra-slice manager is responsible for collecting scenario information and determining an allocation/re-allocation scheme of spectrum resources inside a RAN slice, the NSSMF is responsible for determining an orchestration/re-orchestration scheme of spectrum resources among RAN slices and a slice maximum capacity, the NSMF is responsible for determining an interference relationship (for example, an inter-slice sharing factor) between RNA slices, and the CSMF performs a certain degree of processing on the scenario information to facilitate further processing by subsequent entities.

Table 2 illustrates entities involved in interactions among information flows in FIGS. 6 to 8.

TABLE 2

| | |
|---|---|
| Access and mobility management function | AMF |
| Communication service management function | CSMF |
| Network slice management function | NSMF |
| Network slice selection function | NSSF |
| Network slice subnet management function | NSSMF |
| Network repository function | NRF |
| Network slice quota | NSQ |
| Operation administration and maintenance | OAM |
| Policy control function | PCF |
| Unified data management | UDM |
| Unified data repository | UDR |
| User Equipment | UE |

First, a first information flow example in this specific embodiment will be described with reference to FIG. 6.

As shown in FIG. 6, at step 1, the intra-slice manager collects scenario information of a RAN slice for which it is responsible, and transmits the collected scenario information to the CSMF. For example, the intra-slice manager can transmit the scenario information such as base station position, base station transmit power, spectrum resource requirement and communication service requirement of base station to the CSMF.

The CSMF, at step 2, processes the received scenario information. For example, the CSMF can determine a RAN slice priority based on the communication service requirement included in the scenario information as described above. For another example, the CSMF can determine a RAN slice spectrum resource requirement based on the spectrum resource requirement of the base station included in the scenario information as described above. Alternatively, the CSMF can also perform some intermediate processing on the scenario information to facilitate subsequent operations of other entities.

The CSMF can, at step 3, transmit the processed scenario information to the NSMF. Here, the processed scenario information includes information obtained after processing the original scenario information and the original scenario information required (for example, required for obtaining the interference relationship between RAN slices, the RAN slice priority, and the RAN slice spectrum resource requirement) by other entities for subsequent operations.

At step 4, the NSMF can further process the information received from the CSMF. For example, the NSMF can determine the interference relationship between RAN slices based on information such as the base station position and transmit power, and further determine an inter-slice sharing factor.

At step 5, the NSMF can transmit the further processed scenario information to the NSSMF. Here, the further processed scenario information includes the information obtained after processing the information received from the CSMF and the original scenario information that may be required by other entities for subsequent operations/the information received from the CSMF (for example, can be information required by the NSSMF for determining the interference relationship between slices to determine the slice maximum capacity, such as the original base station position/transmit power, or a base station interference relationship matrix (for example, can be determined by the CSMF)).

At step 6, the NSSMF determines an orchestration/re-orchestration scheme of spectrum resources among the RAN slices based on the received information, and further determines a slice maximum capacity of each RAN slice involved.

At step 7, the NSSMF can transmit the slice maximum capacity to an entity recording changes in a network slice load (for example, UDR/UDM in this example), to facilitate triggering the re-orchestration of spectrum resources among the RAN slices upon the entity detecting that the load of the RAN slice exceeds the slice maximum capacity.

At step 8, the NSSMF can transmit the orchestration/re-orchestration scheme of spectrum resources among the RAN slices and the slice maximum capacity to an entity for determining the allocation/re-allocation scheme of spectrum resources inside the slice (for example, the intra-slice manager in this embodiment).

At step 9, the intra-slice manager can determine an allocation scheme of spectrum resources among base stations in a RAN.

Steps 10 to 14 involve information interactions among several entities, i.e. UE, AMF, PCF, UDR/UDM and OAM. These information interactions are intended to determine, according to a maximum user number quota of a network slice (for example, a RAN slice discussed mainly in this disclosure), whether a request for registering a UE to a certain network slice (for example, a RAN slice concerned in this disclosure) can be accepted based on the spectrum resources currently allocated to each RAN slice. These steps have been specified, for example, in solution #1 of 3GPP TR 23.700-40 v0.3.0, and will not be described in detail here. It should be noted that in the context of the solution of the present disclosure, a “user number quota” can correspond to a “capacity” in the present disclosure. Therefore, a total quota for a maximum number of users involved at the step 10 can correspond to a sum of the slice maximum capacities of all the slices involved, and a local quota for a maximum number of users involved at the step 11 can correspond to the slice maximum capacity of the current slice to be registered by a user.

In the case where it is determined by the PCF and the AMF in the steps 10 to 14 that the request for registering the UE to the corresponding RAN slice can be accepted, the UE can transmit, to the intra-slice manager at step 15, a request for registration to the corresponding RAN slice managed by the intra-slice manager.

In some cases, for example, the case where spectrum resources of a base station to serve the UE are insufficient, the registration request of the UE can trigger re-allocation of spectrum resources among base stations in the slice at step 16. In addition, at step 17, since a new UE is registered to a certain network slice, the PCF and UDR/UDM can update and re-allocate the quota for the slice.

In the case where it is determined by the PCF and AMF in the steps 10 to 14 that the spectrum resources of the RAN slice requested by the UE for registration are insufficient to cope with the new UE to be added (for example, the adding of the UE will cause the load of the RAN slice to exceed its slice maximum capacity), the PCF can notify the NSSMF to perform re-orchestration of spectrum resources among the RAN slices (step 18). And at step 19, the PCF and UDR/UDM can update the local quota based on the new slice maximum capacity determined after the re-orchestration of spectrum resources.

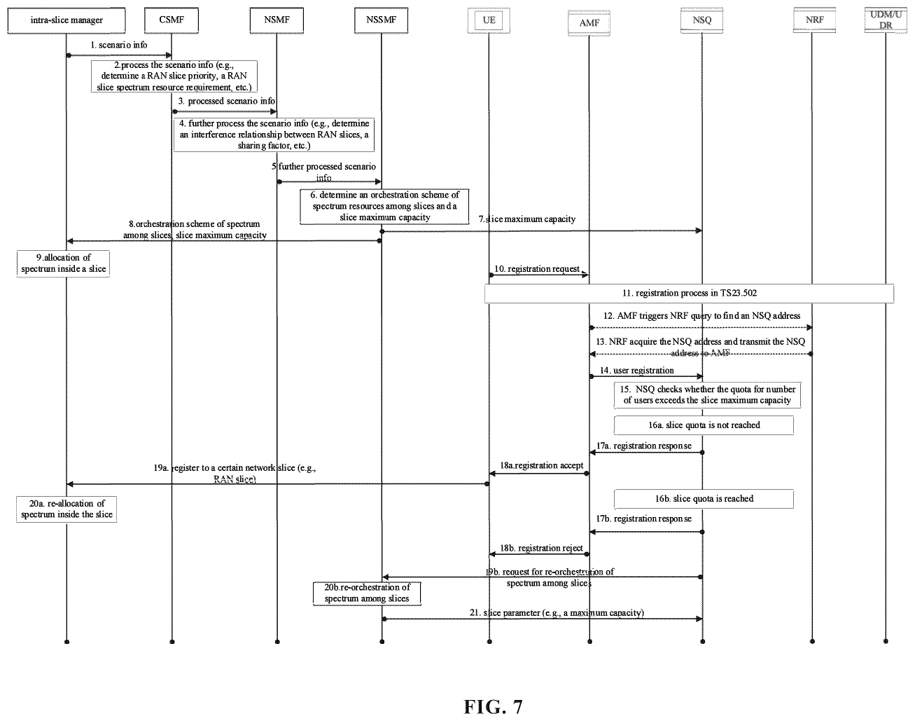

Hereinafter, a second information flow example in the above specific embodiment according to the present disclosure will be described with reference to FIG. 7.

Steps 1 to 6 of the second information flow example shown in FIG. 7 are similar to those of the first information flow example described with reference to FIG. 6, and will not be repeated here.

At step 7, different from the first information flow example, the NSSMF transmits the slice maximum capacity to the NSQ serving as the entity recording changes in a network slice load, to facilitate triggering the re-orchestration of spectrum resources among the RAN slices upon the NSQ detecting the load of the RAN slice exceeds the slice maximum capacity.

At step 8, similar to the first information flow example, the NSSMF can transmit the orchestration/re-orchestration scheme of spectrum resources among the RAN slices and the slice maximum capacity to the intra-slice manager serving as the entity for determining an allocation/re-allocation scheme of spectrum resources inside a slice.

At step 9, the intra-slice manager can determine an allocation scheme of spectrum resources among base stations in a RAN.

Steps 10 to 18 involve information interactions among several entities, i.e. UE, AMF, NSQ, NRF and UDM/UDR. These information interactions are intended to determine, according to a maximum user number quota (in other words, a slice maximum capacity) of a network slice (for example, a RAN slice discussed mainly in this disclosure), whether a request for registering a UE to a certain network slice (for example, a RAN slice concerned in this disclosure) can be accepted based on the spectrum resources currently allocated to each RAN slice. These steps have been specified, for example, in solution #2 of 3GPP TR 23.700-40 v0.3.0, and will not be described in detail here.

At step 19a, in the case where the UE can be registered to the corresponding RAN slice, if spectrum resources of a base station to serve the UE are insufficient, the registration request of the UE can trigger re-allocation of spectrum resources among base stations in the slice at step 20a.

At step 18b, since the spectrum resources of the RAN slice requested by the UE for registration are insufficient to cope with the new UE to be added, in the case where the registration request of the UE is rejected, at step 19b, the NSQ can request the NSSMF to perform re-orchestration of spectrum resources among the RAN slices (step 20b). And, at step 21, the NSSMF can transmit, to the NSQ, a new slice maximum capacity determined after the re-orchestration of spectrum resources.

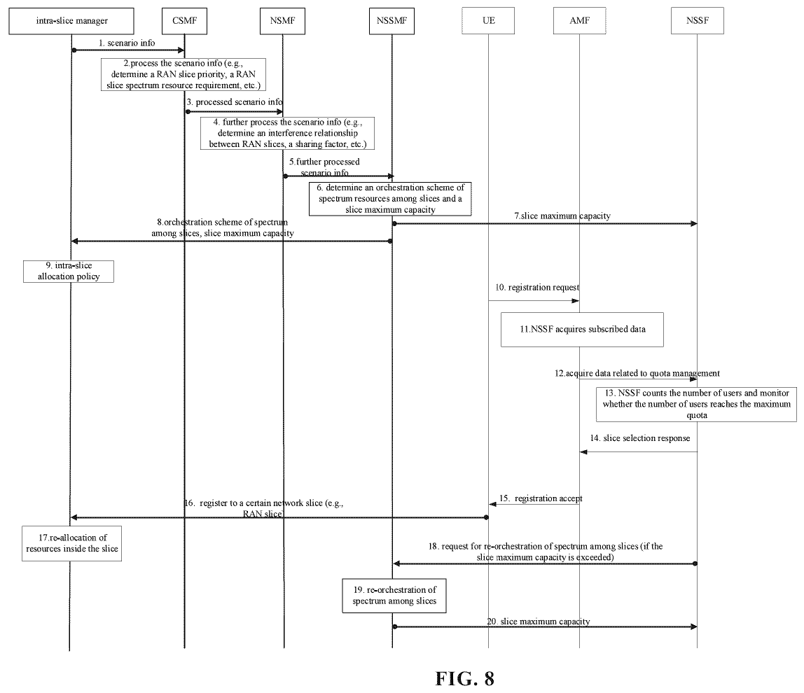

Hereinafter, a third information flow example in the above specific embodiment according to the present disclosure will be described below with reference to FIG. 8.

Steps 1 to 6 of the third information flow example shown in FIG. 8 are similar to those of the first information flow example described with reference to FIG. 6, and will not be repeated here. At step 7, different from the first and second information flow examples, the NSSMF transmits a slice maximum capacity to the NSSF serving as the entity recording changes in a network slice load, to facilitate triggering the re-orchestration of spectrum resources among RAN slices upon the NSSF detecting that the load of the RAN slice exceeds the slice maximum capacity.

At step 8, similar to the first and second information flow examples, the NSSMF can transmit an orchestration/re-orchestration scheme of spectrum resources among the RAN slices and the slice maximum capacity to the intra-slice manager serving as the entity for determining an allocation/re-allocation scheme of spectrum resources inside a slice.

At step 9, the intra-slice manager can determine an allocation scheme of spectrum resources among base stations in a RAN.

Steps 10 to 15 involve information interactions among several entities, i.e. UE, AMF and NSSF. These information interactions are intended to determine, according to a maximum user number quota (in other words, the slice maximum capacity) of a network slice (for example, a RAN slice discussed mainly in this disclosure), whether a request for registering a UE to a certain network slice (for example, a RAN slice concerned in this disclosure) can be accepted based on the spectrum resources currently allocated to each RAN slice. These steps have been specified, for example, in solution #3 of 3GPP TR 23.700-40 v0.3.0, and will not be described in detail here.

At step 16, in the case where the UE can be registered to the corresponding RAN slice, if spectrum resources of a base station to serve the UE are insufficient, the registration request of the UE can trigger re-allocation of spectrum resources among base stations in the slice at step 17.

At step 18, in the case where the NSSF has counted that the number of users reaches the slice maximum capacity, the NSSF can request the NSSMF to perform re-orchestration of spectrum resources among the RAN slices at step 18, and at step 20, the NSSMF can transmit, to the NSSF, a new slice maximum capacity determined after the re-orchestration of spectrum resources.

The three information flow examples according to the one specific embodiment of the present disclosure have been briefly described with reference to FIGS. 6 to 8. It should be noted that the information flows of FIGS. 6 to 8 are merely schematic. The order of the information transmission in FIGS. 6 to 8 can be further adjusted as appropriate, and can also include some other information flows not shown. For example, the step 7 of transmitting the slice maximum capacity to the entity recording changes in a network slice load can be performed in parallel or in a reverse order with the step 8 of transmitting the re-orchestration scheme of spectrum resources among the slices and the slice maximum capacity to the intra-slice manager. For another example, in the case of performing the re-orchestration of spectrum resources among the slices or performing the reconfiguration of spectrum resources inside the slice, new scenario information collection/processing process may be involved. That is, step(s) similar to one or more steps of the steps 1 to 6 can be additionally included before the step 18 or 16 of FIG. 6, or before the step 20b or 20a of FIG. 7, or before the step 19 or 17 of FIG. 8. In addition, the specific content of the information transmitted in each step can be slightly different depending on the specific situation. For example, specific operation(s) involved in processing the scenario information can be performed by one or more corresponding entities of the intra-slice manager, the CSMF, the NSMF, and the NSSMF as appropriate, and therefore, the information transmitted in the steps 1 to 6 can vary according to the specific operation (s) performed by each entity. For example, the RAN slice spectrum resource requirement can be determined by the NSMF in place of the CSMF, and in this case, the CSMF can simply forward, to the NSMF, the original scenario information required for determining the RAN slice spectrum resource requirement. Further, the information transmitted to the entity recording changes in a network slice load can also comprise other parameters than the slice maximum capacity.

The solution of the present disclosure has been described in detail above with reference to the accompanying drawings. In the solution of the present disclosure, it is advantageous to make the spectrum resources between the plurality of RAN slices partially overlap according to the degree (i.e., sharing factor) accepted by each RAN slice, which improves the spectrum satisfaction of each RAN slice and improves spectrum utilization. According to another aspect, in the solution of the present disclosure, by limiting the timing for triggering the re-orchestration of spectrum resources, the complexity of the re-orchestration of spectrum resources among the spectrum is advantageously reduced. Furthermore, in the solution of the present disclosure, by making the quantity of spectrum resources having been allocated to existing RAN slices be re-allocated to other RAN slices as little as possible, and by making the quantity of spectrum resources having been allocated to base stations be re-allocated to base stations as possible, the complexity of the re-orchestration of spectrum resources among the spectrum and the re-allocation of spectrum resources inside the slice is further reduced.

In addition, the solution of the present disclosure can also support a scenario of spectrum resource allocation across operators. In this scenario, different RAN slices can be operated by different operators. The solution of the present disclosure can enable spectrum resource sharing and flexible spectrum resource allocation across the operators.

Effects of the solution of the present disclosure will be described below by means of simulation results.

Table 3 shows a parameter table set for simulation, where channels represent spectrum resources.

TABLE 3

| Parameter | Value |
|---|---|
| Region | 1000 m * 1000 m |

| | | |
|---|---|---|
| Number of base stations | Slice 1 | 20 |
| | Slice 2 | 20 |
| | Slice 3 | 20 |

| Frequency | 3500 | MHz |
|---|---|---|
| Number of channels | 30 | |
| Bandwidth | 5 | MHz |
| Transmit power | 17~23 | dBm |

| | | |
|---|---|---|
| Priority | Slice 1 | 0.1 |
| | Slice 2 | 0.2 |
| | Slice 3 | 0.7 |
| First sharing factor | Slice 1 | 1 |
| | Slice 2 | 0 |
| | Slice 3 | 1 |
| Slice channel requirement | Slice 1 | 9 |
| | Slice 2 | 12 |
| | Slice 3 | 15 |
| Base station channel | Slice 1 | 3 |
| requirement | Slice 2 | 3 |
| | Slice 3 | 3 |

In table 3, the base station channel requirement represents the quantity of spectrum resources required by each base station, and in this simulation example, the channel requirement of each base station of each slice is the same.

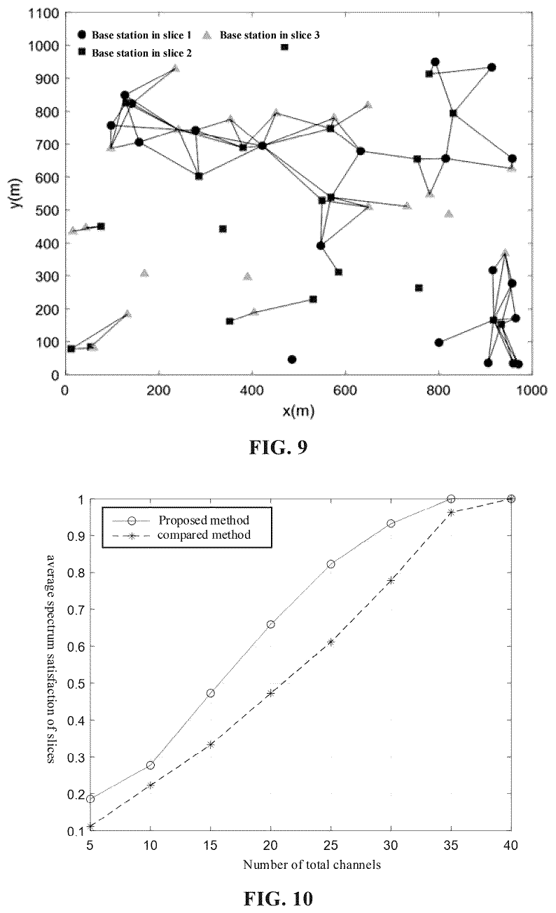

FIG. 9 exemplarily illustrates a diagram of a base station position scenario representing the simulation.

In the scenario shown in FIG. 9, inter-slice sharing factors determined by using the parameters shown in table 3 are shown in Table 4.

TABLE 4

| | Slice 1 | Slice 2 | Slice 3 |
|---|---|---|---|
| Slice 1 | 1 | 0 | 0.35 |
| Slice 2 | 0 | 1 | 0 |
| Slice 3 | 0.5 | 0 | 1 |

Table 5 shows simulation results of determining an orchestration scheme of channels among slice 1 to slice 3 by using the parameters shown in the table 3 in the scenario shown in FIG. 9.

TABLE 5

| | Slice 1 | Slice 2 | Slice 3 |
|---|---|---|---|
| Number of allocated channels | 9 | 12 | 12 |
| Slice spectrum satisfaction | 100% | 100% | 80% |

FIG. 10 shows a comparison diagram of spectrum resource (i.e., channel) satisfaction of slices by using the solution of the present disclosure and a solution of allocating separate spectrum resources to slices without considering inter-slice spectrum resource sharing. As shown in FIG. 10, in the case where total spectrum resources are finite (for example, the number of total channels is less than 40), compared with the solution of allocating separate spectrum resources among slices, the solution of the present disclosure can satisfy the requirements of the slices for the spectrum resources to a greater degree, thereby effectively improving the spectrum resource satisfaction of the slices.

Table 6 shows simulation results of determining an allocation scheme of spectrum inside each slice by using the parameters shown in the Table 3 in the scenario shown in FIG. 9.

TABLE 6

| | Slice 1 | Slice 2 | Slice 3 |
|---|---|---|---|
| Number of base stations | 20 | 20 | 20 |
| Base station channel requirement | 3 | 3 | 3 |
| Average spectrum satisfaction | 90% | 100% | 100% |
| of base stations | | | |

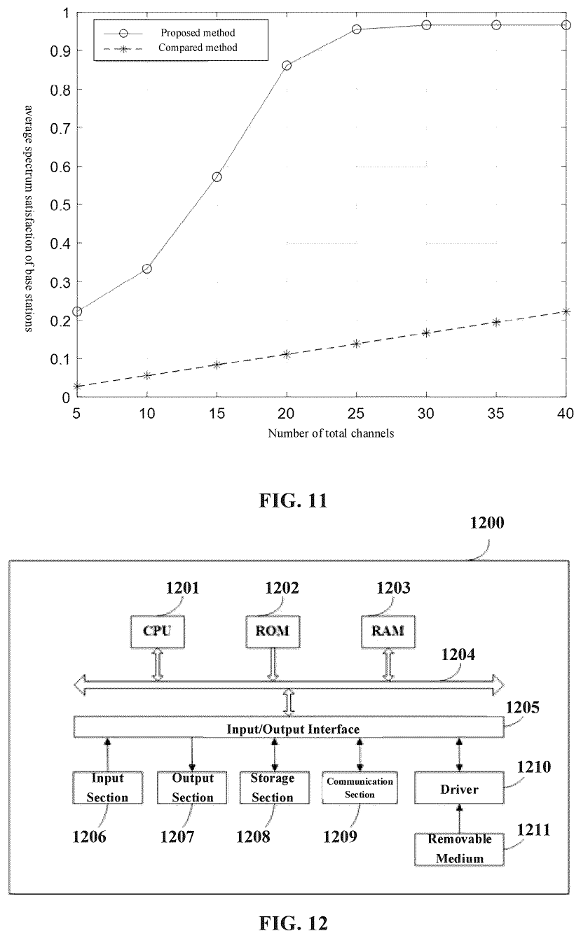

FIG. 11 shows a comparison diagram of spectrum resource (i.e., channel) satisfaction of slices by using the solution of the present disclosure and a solution of allocating separate spectrum resources to slices without considering inter-slice spectrum resource sharing. As shown in FIG. 11, in the case where total spectrum resources are finite (for example, the number of total channels is less than 40), compared with the solution of allocating separate spectrum resources among slices, since the solution of the present disclosure can provide more spectrum resources for slices, it can also satisfy requirements of base stations in the slices for spectrum resources to a greater degree, thereby effectively improving the spectrum resource satisfaction of the base stations.

The solution of the present disclosure has been described through various embodiments. It should be noted that the above embodiments are merely exemplary. The solution of the present disclosure can also be implemented in other ways and still have the advantageous effects obtained by the above embodiments.

In addition, it should be understood that the above series of processes, system, and devices in the system can also be implemented by software and/or firmware. In the case of implementation by software and/or firmware, a program constituting the software is installed, via a storage medium or a network, on a computer having a dedicated hardware structure, such as a general-purpose computer/computer system 1200 shown in FIG. 12, wherein the computer, when having various programs installed therein, can execute various functions and the like. FIG. 12 is a block diagram of an example structure of an employable computer/computer system in an embodiment of the present disclosure. While shown as a block diagram of a single structure, functions of the computer/computer system 1200 can be implemented as a distributed system. For example, while some processes can be performed using one processor, other processes are performed using other remote processors. Other elements of the computer/computer system 1200 can also be similarly distributed. Furthermore, the functions disclosed herein can be implemented on separate servers or devices that can be coupled together through a network. Furthermore, one or more components of the system 1200 may not be included.

In some embodiments, the computer/computer system 1200 can, as a whole, be used for implementing the system 20 shown in FIG. 2. In this case, in particular, the various devices comprised in the system 20 can be collaboratively implemented by the various components in the system 1200 as modules that implement the corresponding functions. In some embodiments, the plurality of devices comprised in the system 20 shown in FIG. 2 can be implemented by separate computers/computer systems 1200. In some embodiments, some of the devices comprised in the system 20 shown in FIG. 2 can be implemented by separate computers/computer systems 1200, and others can be implemented by one computer/computer system 1200 as a whole.

In FIG. 12, a Central Processing Unit (CPU) 1201 executes various processes according to a program stored in a Read-Only Memory (ROM) 1202 or a program loaded from a storage section 1208 to a Random Access Memory (RAM) 1203. In the RAM 1203, data required when the CPU 1201 executes various processes and the like is also stored as needed.

The CPU 1201, the ROM 1202, and the RAM 1203 are connected to each other via a bus 1204. An input/output interface 1205 is also connected to the bus 1204.

The following components are connected to the input/output interface 1205: an input section 1206 including a keyboard, a mouse, and the like; an output section 1207 including a display such as a Cathode Ray Tube (CRT), a Liquid Crystal Display (LCD), and a speaker, and the like; a storage section 1208 including a hard disk and the like; and a communication section 1209 including a network interface card such as a LAN card, a modem, and the like. The communication section 1209 performs communication processing via a network such as the Internet.

A driver 1210 is also connected to the input/output interface 1205 as needed. A removable medium 1211 such as a magnetic disk, an optical disk, a magneto-optical disk, a semiconductor memory, or the like, is mounted on the drive 1210 as needed, so that a computer program read out therefrom is installed into the storage section 1208 as needed.

In the case where the above series of processes is implemented by software, a program constituting the software is installed from a network such as the Internet or a storage medium such as the removable medium 1211.

It should be understood by those skilled in the art that such a storage medium is not limited to the removable medium 1211 shown in FIG. 12 which has programs stored therein and is distributed separately from the device to provide the programs to a user. Examples of the removable medium 1211 include a magnetic disk (including a floppy disk (registered trademark)), an optical disk (including a Compact Disk Read-Only Memory (CD-ROM) and a Digital Versatile Disc (DVD)), a magneto-optical disk (including a Mini Disk (MD) (registered trademark)), and a semiconductor memory. Alternatively, the storage medium can be the ROM 1202, the hard disk included in the storage section 1208, and the like, which have programs stored therein and are distributed to the user together with a device including them.

The exemplary embodiments of the present disclosure have been described above with reference to the drawings, but the present disclosure is of course not limited to the above examples. Those skilled in the art can obtain various changes and modifications within the scope of the attached claims, and should understood that these changes and modifications will naturally fall within the technical scope of the present disclosure.

It should be understood that machine-executable instructions in a machine-readable storage medium or program product according to the embodiments of the present disclosure can be configured for performing operations corresponding to the above system and method embodiments. Embodiments of the machine-readable storage medium or program product, when referring to the above system and method embodiments, will be apparent to those skilled in the art, and therefore, will not be repeated. The machine-readable storage medium and program product for carrying or including the above machine-executable instructions also fall within the scope of the present disclosure. Such a storage medium can include, but is not limited to, a floppy disk, an optical disk, a magneto-optical disk, a memory card, a memory stick, and the like.

It should also be understood that the embodiments of the present disclosure can also take a form of a hardware circuit. The hardware circuit can include any combination of a combinational logic circuit, a clock storage device (such as a floppy disk, a trigger, a latch, etc.), a finite state machine, a memory such as a static random access memory or an embedded dynamic random access memory, a customized design circuit, a programmable logic array, etc.

In this specification, the steps described in the flow diagrams include not only the processes performed chronologically in the order, but also the processes performed in parallel or separately, rather than necessarily chronologically. Furthermore, even in steps processed chronologically, needless to say, the order can also be changed as appropriate.

Although the present disclosure and its advantages have been described in detail, it should be understood that various changes, substitutions and transformations can be made herein without departing from the spirit and scope of the present disclosure that are defined by the attached claims. Furthermore, the terms “include”, “comprise”, or any other variation thereof, in the embodiments of the present disclosure are intended to cover a non-exclusive inclusion, such that a process, method, object, or device including a series of elements not only includes those elements, but also includes other elements not expressly listed, or also includes elements inherent to such a process, method, object, or device. Without further limitations, an element defined by the phrase “comprising a . . . ” does not exclude the presence of other identical elements in a process, method, object, or device that comprises the element.

Furthermore, the present disclosure can also have the following configurations:
(1) A system for wireless communication, comprising:
one or more intra-slice managers, at least one of the one or more intra-slice managers is configured for collecting scenario information of a corresponding Radio Access Network (RAN) slice of a plurality of RAN slices in a wireless network, wherein, the scenario information is used for determining at least the following information: an interference relation between RAN slices, a RAN slice priority and a RAN slice spectrum resource requirement;
a first management means, configured for determining an orchestration or re-orchestration scheme of spectrum resources among the plurality of RAN slices at least based on the scenario information, wherein the orchestration or re-orchestration scheme of spectrum resources among the plurality of RAN slices includes a first characteristic and quantity of spectrum resources to be allocated to at least one RAN slice of the plurality of RAN slices.
(2) The system of (1), wherein
the scenario information at least indicates one or more of the following: a base station position, base station transmit power, a spectrum resource requirement of a base station and a communication service requirement.
(3) The system of (1) or (2), wherein
the system further comprising a second management means, configured for determining an inter-slice sharing factor representing a degree at which a RAN can share spectrum resources with other RAN slices based on the scenario information, and transmitting the determined inter-slice sharing factor to the first management means for the first management means to determine the orchestration or re-orchestration scheme of spectrum resources among the plurality of RAN slices.
(4) The system of (3), wherein determining the inter-slice sharing factor comprising:
determining a first sharing factor for the at least one RAN slice of the plurality of RAN slices based on a communication service requirement indicated by the scenario information,
determining a second sharing factor for any two RAN slices of the plurality of RAN slices based on the interference relation between RAN slices; and
for any two RAN slices of the plurality of RAN slices, determining the inter-slice sharing factor for said two RAN slices based on a minimum value of between the first sharing factor and the second sharing factor.
(5) The system according to (1) or (2), wherein
the first management means determines the orchestration or re-orchestration scheme of spectrum resources among the plurality of RAN slices such that one or more of the following is satisfied:
in the orchestration of spectrum resources, making the spectrum resource requirement of a RAN slice allowing a higher spectrum resources sharing degree be satisfied to a higher degree; and
in the re-orchestration scheme of spectrum resources, making the quantity of the spectrum having been allocated to existing RAN slices be re-allocated to other RAN slices as little as possible.
(6) The system of (1) or (2), wherein
the first characteristic of a spectrum resource at least indicates the type of a spectrum resource including: a spectrum resource not allocated to any RAN slice, a spectrum resource allocated to a RAN slice but not yet used by the RAN slice, and a spectrum resource capable of overlapping with spectrum resources allocated to a RAN slice, and
in determining the re-orchestration scheme of spectrum resources among the plurality of RAN slices, the first management means allocates spectrum resources in the following order: spectrum resources not allocated to any RAN slice, spectrum resources allocated to a RAN slice but not yet used by the RAN slice, and spectrum resources capable of overlapping with spectrum resources allocated to a RAN slice.
(7) The system according to (1) or (2), wherein
the scenario information further indicates an interference relation inside a RAN slice, and
the first management means determines a slice maximum capacity of at least one RAN slice of the plurality of RAN slices at least based on the interference relation inside a RAN slice and the quantity of spectrum resources to be allocated to the at least one RAN slice of the plurality of RAN slices.
(8) The system of (7), wherein
in response to a load of a RAN slice exceeding the determined slice maximum capacity of the RAN slice, or in response to a new RAN slice being generated in the wireless network, the first management means performs the re-orchestration of spectrum resources.
(9) The system of (7), wherein
the first management means transmits the determined slice maximum capacity of the at least one RAN slice to the at least one intra-slice manager and an entity recording changes in network slice load in the wireless network.
(10) The system of (9), wherein
the entity recording changes in network slice load comprising one or more of entities realizing the following functions: Unified Data Repository (UDR)/Unified Data Management (UDM), Operation Administration and Maintenance (OAM), Network Slice Quota (NSQ) or Network Slice Selection Function (NSSF).
(11) The system of (1) or (2), wherein
the at least one intra-slice manager is further configured to determine an allocation or re-allocation scheme of spectrum resources inside the corresponding RAN slice at least based on the first characteristic and/or quantity of the spectrum resources to be allocated to the corresponding RAN slice of the plurality of RAN slices, wherein an allocation or re-allocation scheme of spectrum resources inside one RAN slice includes a second characteristic and quantity of spectrum resources to be allocated to at least one base station in the RAN slice.
(12) The system of (11), wherein
the at least one intra-slice manager determines the re-allocation scheme of spectrum resources inside the RAN slice such that a number of re-allocations of spectrum resources having been allocated to any base station to other base stations as little as possible, and/or
the second characteristic of the spectrum resources at least indicates the type of spectrum resources including: a spectrum resource not allocated to any base station, a spectrum resource allocated to a base station but not yet used by the base station, and a spectrum resource capable of overlapping with spectrum resources allocated to a base station, and in determining the re-allocation scheme of spectrum resources inside the RAN slice, the at least one intra-slice manager allocates spectrum resources in the following order: spectrum resources not allocated to any base station, spectrum resources allocated to a base station but not yet used by the base station, and spectrum resources capable of overlapping with spectrum resources allocated to a base station.
(13) The system of (3), wherein
the system further comprising a third management means, configured to receive the scenario information from the at least one intra-slice manager, and transmitting the originally received scenario information or processed scenario information to the second management means.
(14) A method for a system for wireless communication, the system comprising one or more intra-slice managers and a first management means, the method comprising:
collecting, by at least one intra-slice manager of the one or more intra-slice managers, scenario information of a corresponding Radio Access Network (RAN) slice of a plurality of RAN slices in a wireless network, wherein, the scenario information is used for determining at least the following information: an interference relation between RAN slices, a RAN slice priority and a RAN slice spectrum resource requirement; and
determining, by the first management means, an orchestration or re-orchestration scheme of spectrum resources among the plurality of RAN slices at least based on the interference relation between RAN slices, the RAN slice priority and the RAN slice spectrum resource requirement, wherein the orchestration or re-orchestration scheme of spectrum resources among the plurality of RAN slices includes a first characteristic and quantity of spectrum resources to be allocated to at least one RAN slice of the plurality of RAN slices.
(15) The method of (14), the system further comprising a second management means,
the method further comprising determining, by the second management means, an inter-slice sharing factor representing a degree at which a RAN can share spectrum resources with other RAN slices based on the scenario information, and transmitting the determined inter-slice sharing factor to the first management means for the first management means to determine the orchestration or re-orchestration scheme of spectrum resources among the plurality of RAN slices.
(16) The method of (15), wherein the first management means determines the orchestration or re-orchestration scheme of spectrum resources among the plurality of RAN slices such that one or more of the following is satisfied:
in the orchestration of spectrum resources, making the spectrum resource requirement of a RAN slice allowing a higher spectrum resources sharing degree be satisfied to a higher degree; and
in the re-orchestration scheme of spectrum resources, making the quantity of the spectrum having been allocated to existing RAN slices be re-allocated to other RAN slices as little as possible.
(17) The method of (14) or (15), wherein the scenario information is further used for determining an interference relationship inside a RAN slice, and the method further comprising, by the first management means:
determining a slice maximum capacity of at least one RAN slice of the plurality of RAN slices at least based on the interference relation inside a RAN slice and the quantity of spectrum resources to be allocated to the at least one RAN slice of the plurality of RAN slices, and
transmitting the determined slice maximum capacity of the at least one RAN slice to the at least one intra-slice manager and an entity recording changes in network slice load in the wireless network.
(18) The method of (17), wherein
in response to a load of a RAN slice exceeding the determined slice maximum capacity of the RAN slice, or in response to a new RAN slice being generated in the wireless network, the first management means performs the re-orchestration of spectrum resources.
(19) The method of (14) or (15), wherein the method further comprising:
determining, by the at least one intra-slice manager, an allocation or re-allocation scheme of spectrum resources inside the corresponding RAN slice at least based on the first characteristic and/or quantity of the spectrum resources to be allocated to the corresponding RAN slice of the plurality of RAN slices, wherein an allocation or re-allocation scheme of spectrum resources inside one RAN slice includes a second characteristic and quantity of spectrum resources to be allocated to at least one base station in the RAN slice.
(20) A non-transitory computer-readable storage medium having executable instructions stored thereon which, when executed, implement the method of any of (14) to (19).

1. A system for wireless communication, comprising:
one or more intra-slice managers, at least one of the one or more intra-slice managers is configured for collecting scenario information of a corresponding Radio Access Network (RAN) slice of a plurality of RAN slices in a wireless network, wherein, the scenario information is used for determining at least the following information: an interference relation between RAN slices, a RAN slice priority and a RAN slice spectrum resource requirement;
a first management means, configured for determining an orchestration or re-orchestration scheme of spectrum resources among the plurality of RAN slices at least based on the scenario information, wherein the orchestration or re-orchestration scheme of spectrum resources among the plurality of RAN slices includes a first characteristic and quantity of spectrum resources to be allocated to at least one RAN slice of the plurality of RAN slices.

2. The system of claim 1, wherein
the scenario information at least indicates one or more of the following: a base station position, base station transmit power, a spectrum resource requirement of a base station and a communication service requirement.

3. The system of claim 1, wherein
the system further comprising a second management means, configured for determining an inter-slice sharing factor representing a degree at which a RAN can share spectrum resources with other RAN slices based on the scenario information, and transmitting the determined inter-slice sharing factor to the first management means for the first management means to determine the orchestration or re-orchestration scheme of spectrum resources among the plurality of RAN slices.

4. The system of claim 3, wherein determining the inter-slice sharing factor comprising:
determining a first sharing factor for the at least one RAN slice of the plurality of RAN slices based on a communication service requirement indicated by the scenario information,
determining a second sharing factor for any two RAN slices of the plurality of RAN slices based on the interference relation between RAN slices, and
for any two RAN slices of the plurality of RAN slices, determining the inter-slice sharing factor for said two RAN slices based on a minimum value of between the first sharing factor and the second sharing factor.

5. The system according to claim 1, wherein
the first management means determines the orchestration or re-orchestration scheme of spectrum resources among the plurality of RAN slices such that one or more of the following is satisfied:
in the orchestration of spectrum resources, making the spectrum resource requirement of a RAN slice allowing a higher spectrum resources sharing degree be satisfied to a higher degree; and
in the re-orchestration scheme of spectrum resources, making the quantity of the spectrum having been allocated to existing RAN slices be re-allocated to other RAN slices as little as possible.

6. The system of claim 1, wherein
the first characteristic of a spectrum resource at least indicates the type of a spectrum resource including: a spectrum resource not allocated to any RAN slice, a spectrum resource allocated to a RAN slice but not yet used by the RAN slice, and a spectrum resource capable of overlapping with spectrum resources allocated to a RAN slice, and
in determining the re-orchestration scheme of spectrum resources among the plurality of RAN slices, the first management means allocates spectrum resources in the following order: spectrum resources not allocated to any RAN slice, spectrum resources allocated to a RAN slice but not yet used by the RAN slice, and spectrum resources capable of overlapping with spectrum resources allocated to a RAN slice.

7. The system according to claim 1, wherein
the scenario information further indicates an interference relation inside a RAN slice, and
the first management means determines a slice maximum capacity of at least one RAN slice of the plurality of RAN slices at least based on the interference relation inside a RAN slice and the quantity of spectrum resources to be allocated to the at least one RAN slice of the plurality of RAN slices.

8. The system of claim 7, wherein
in response to a load of a RAN slice exceeding the determined slice maximum capacity of the RAN slice, or in response to a new RAN slice being generated in the wireless network, the first management means performs the re-orchestration of spectrum resources.

9. The system of claim 7, wherein
the first management means transmits the determined slice maximum capacity of the at least one RAN slice to the at least one intra-slice manager and an entity recording changes in network slice load in the wireless network.

10. (canceled)

11. The system of claim 1, wherein
the at least one intra-slice manager is further configured to determine an allocation or re-allocation scheme of spectrum resources inside the corresponding RAN slice at least based on the first characteristic and/or quantity of the spectrum resources to be allocated to the corresponding RAN slice of the plurality of RAN slices, wherein an allocation or re-allocation scheme of spectrum resources inside one RAN slice includes a second characteristic and quantity of spectrum resources to be allocated to at least one base station in the RAN slice.

12. The system of claim 11, wherein
the at least one intra-slice manager determines the re-allocation scheme of spectrum resources inside the RAN slice such that a number of re-allocations of spectrum resources having been allocated to any base station to other base stations as little as possible, and/or
the second characteristic of the spectrum resources at least indicates the type of spectrum resources including: a spectrum resource not allocated to any base station, a spectrum resource allocated to a base station but not yet used by the base station, and a spectrum resource capable of overlapping with spectrum resources allocated to a base station, and in determining the re-allocation scheme of spectrum resources inside the RAN slice, the at least one intra-slice manager allocates spectrum resources in the following order: spectrum resources not allocated to any base station, spectrum resources allocated to a base station but not yet used by the base station, and spectrum resources capable of overlapping with spectrum resources allocated to a base station.

13. The system of claim 3, wherein
the system further comprising a third management means, configured to receive the scenario information from the at least one intra-slice manager, and transmitting the originally received scenario information or processed scenario information to the second management means.

14. A method for a system for wireless communication, the system comprising one or more intra-slice managers and a first management means, the method comprising:
collecting, by at least one intra-slice manager of the one or more intra-slice managers, scenario information of a corresponding Radio Access Network (RAN) slice of a plurality of RAN slices in a wireless network, wherein, the scenario information is used for determining at least the following information: an interference relation between RAN slices, a RAN slice priority and a RAN slice spectrum resource requirement; and
determining, by the first management means, an orchestration or re-orchestration scheme of spectrum resources among the plurality of RAN slices at least based on the interference relation between RAN slices, the RAN slice priority and the RAN slice spectrum resource requirement, wherein the orchestration or re-orchestration scheme of spectrum resources among the plurality of RAN slices includes a first characteristic and quantity of spectrum resources to be allocated to at least one RAN slice of the plurality of RAN slices.

15. The method of claim 14, the system further comprising a second management means,
the method further comprising determining, by the second management means, an inter-slice sharing factor representing a degree at which a RAN can share spectrum resources with other RAN slices based on the scenario information, and transmitting the determined inter-slice sharing factor to the first management means for the first management means to determine the orchestration or re-orchestration scheme of spectrum resources among the plurality of RAN slices.

16. The method of claim 15, wherein the first management means determines the orchestration or re-orchestration scheme of spectrum resources among the plurality of RAN slices such that one or more of the following is satisfied:
in the orchestration of spectrum resources, making the spectrum resource requirement of a RAN slice allowing a higher spectrum resources sharing degree be satisfied to a higher degree; and
in the re-orchestration scheme of spectrum resources, making the quantity of the spectrum having been allocated to existing RAN slices be re-allocated to other RAN slices as little as possible.

17. The method of claim 14, wherein the scenario information is further used for determining an interference relationship inside a RAN slice, and the method further comprising, by the first management means:
determining a slice maximum capacity of at least one RAN slice of the plurality of RAN slices at least based on the interference relation inside a RAN slice and the quantity of spectrum resources to be allocated to the at least one RAN slice of the plurality of RAN slices, and
transmitting the determined slice maximum capacity of the at least one RAN slice to the at least one intra-slice manager and an entity recording changes in network slice load in the wireless network.

18. The method of claim 17, wherein
in response to a load of a RAN slice exceeding the determined slice maximum capacity of the RAN slice, or in response to a new RAN slice being generated in the wireless network, the first management means performs the re-orchestration of spectrum resources.

19. The method of claim 14, wherein the method further comprising:
determining, by the at least one intra-slice manager, an allocation or re-allocation scheme of spectrum resources inside the corresponding RAN slice at least based on the first characteristic and/or quantity of the spectrum resources to be allocated to the corresponding RAN slice of the plurality of RAN slices, wherein an allocation or re-allocation scheme of spectrum resources inside one RAN slice includes a second characteristic and quantity of spectrum resources to be allocated to at least one base station in the RAN slice.

20. A non-transitory computer-readable storage medium having executable instructions stored thereon which, when executed, implement the method of claim 14.

21. A computer program product comprising executable instructions which, when executed, implement the method of claim 14.
